(19) United States
(12) Patent Application Publication
(10) Pub. No.: US 2025/0150316 A1
(43) Pub. Date: May 8, 2025

(54) ENHANCED TRANSMISSION AND RECEPTION FOR REDCAP DEVICES

(71) Applicant: Intel Corporation, Santa Clara, CA (US)

(72) Inventors: Yingyang Li, Beijing (CN); Yi Wang, Beijing (CN); Gang Xiong, Beaverton, OR (US); Debdeep Chatterjee, San Jose, CA (US); Toufiqul Islam, Santa Clara, CA (US)

(21) Appl. No.: 18/837,983

(22) PCT Filed: Apr. 13, 2023
(86) PCT No.: PCT/US2023/018492

§ 371 Date: Aug. 13, 2024

Related U.S. Application Data
(60) Provisional application No. 63/332,610, filed on Apr. 19, 2022.
(60) Provisional application No. 63/333,056, filed on Apr. 20, 2022.

(30) Foreign Application Priority Data
Apr. 19, 2022 (WO) PCT/CN2022/087656

(51) Int. Cl. H04L 27/26; H04L 5/00; H04W 74/0833

(52) U.S. Cl. CPC H04L 27/26025; H04L 5/0044; H04W 74/0833

(57) ABSTRACT

A computer-readable storage medium stores instructions to configure one or more processors of a Further Reduced Capacity (F-RedCap) UE for operation in a 5G NR network, and to cause the F-RedCap UE to perform operations including decoding a PBCH to obtain a numerology parameter. A maximum resource block (RB) allocation is determined for a bandwidth associated with the numerology parameter. The maximum RB allocation is adjusted based on a reduced bandwidth associated with the F-RedCap UE to obtain an adjusted RB allocation. A maximum data rate is determined based on the numerology parameter and the adjusted RB allocation. Data is encoded for an uplink (UE) transmission to a base station. The UE transmission uses the maximum data rate.

### PRIORITY CLAIM

This application claims the benefit of priority to the following patent applications:
International Application No. PCT/CN2022/087656, filed Apr. 19, 2022, and entitled “ENHANCED TRANSMISSION AND RECEPTION MECHANISM FOR REDCAP DEVICES;”
U.S. Provisional Patent Application No. 63/332,610, filed Apr. 19, 2022, and entitled “SYSTEMS AND METHODS TO ENHANCE CONTROL CHANNEL TRANSMISSION FOR REDCAP DEVICES;” and
U.S. Provisional Patent Application No. 63/333,056, filed Apr. 20, 2022, and entitled “DOWNLINK (DL) OR UPLINK (UL) TRANSMISSION FOR REDUCED CAPACITY (REDCAP) DEVICES.”

Each of the above-listed applications is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, (MulteFire, LTE-U), and fifth-generation (5G) networks including 5G new radio (NR) (or 5G-NR) networks, 5G-LTE networks such as 5G NR unlicensed spectrum (NR-U) networks and other unlicensed networks including Wi-Fi, CBRS (OnGo), etc. Other aspects are directed to techniques for enhanced transmission and reception for reduced capability (RedCap) devices.

### BACKGROUND

Mobile communications have evolved significantly from early voice systems to today's highly sophisticated integrated communication platform. With the increase in different types of devices communicating with various network devices, the usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next-generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As the current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed, as well as unlicensed spectrum, is expected in future releases and 5G systems. Such enhanced operations can include techniques for enhanced transmission and reception for reduced capability (RedCap) devices.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2, FIG. 3, and FIG. 4 illustrate various systems, devices, and components that may implement aspects of disclosed embodiments.

FIG. 5 is a diagram of a frequency region for PDSCH reception, in accordance with some aspects.

FIG. 6 is a diagram of a frequency region for PDSCH reception, in accordance with some aspects.

FIG. 7 is a diagram of bandwidth options for a RedCap UE, in accordance with some aspects.

FIG. 8 is a diagram of CORESET repetitions, in accordance with some aspects.

FIG. 9 is a diagram of CORESET repetitions with different CCE-to-REG mapping, in accordance with some aspects.

FIG. 10 is a diagram of CORESET repetitions with non-interleaved CCE-to-REG mapping, in accordance with some aspects.

FIG. 11 is a diagram of CCE-to-REG mapping across two occasions with consecutive REG numbering, in accordance with some aspects.

FIG. 12 is a diagram of CCE-to-REG mapping across two occasions with shifted REG numbering, in accordance with some aspects.

FIG. 13 is a diagram of bundled PDCCH by PDCCH candidates with the same index, in accordance with some aspects.

FIG. 14 is a diagram of bundled PDCCH by PDCCH candidates with different indexes, in accordance with some aspects.

FIG. 15 is a diagram of CCE-to-REG mapping, in accordance with some aspects.

FIG. 16 is a diagram of CCE-to-REG mapping, in accordance with some aspects.

FIG. 17 is a diagram of additional 3 symbols for PDCCH reception by RBW-RedCap UE, in accordance with some aspects.

FIG. 18 is a diagram of additional 3 symbols for PDCCH reception by RBW-RedCap UE, in accordance with some aspects.

FIG. 19 is a diagram of additional 3 symbols for PDCCH reception with CCE offset by RBW-RedCap UE, in accordance with some aspects.

FIG. 20 is a diagram of PDCCH candidates within Y PRBs, in accordance with some aspects.

FIG. 21 is a diagram of inter-BWP FH, in accordance with some aspects.

FIG. 22 is a diagram of inter-BWP FH with DMRS bundling with counting based on available slots, in accordance with some aspects.

FIG. 23 is a diagram of inter-BWP FH with DMRS bundling with counting based on physical slots, in accordance with some aspects.

FIG. 24 is a diagram of inter-BWP FH with DMRS bundling, in accordance with some aspects.

FIG. 25 is a diagram of inter-BWP FH with DMRS bundling, in accordance with some aspects.

FIG. 26 is a diagram of inter-BWP FH, in accordance with some aspects.

FIG. 27 illustrates a block diagram of a communication device such as an evolved Node-B (eNB), a new generation Node-B (gNB) (or another RAN node), an access point (AP), a wireless station (STA), a mobile station (MS), or user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

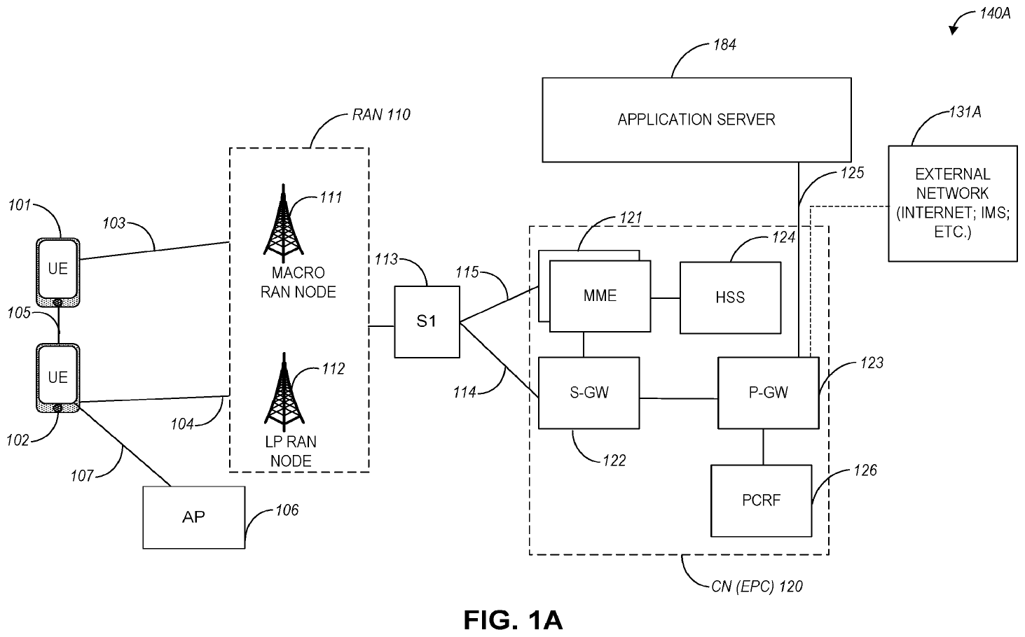

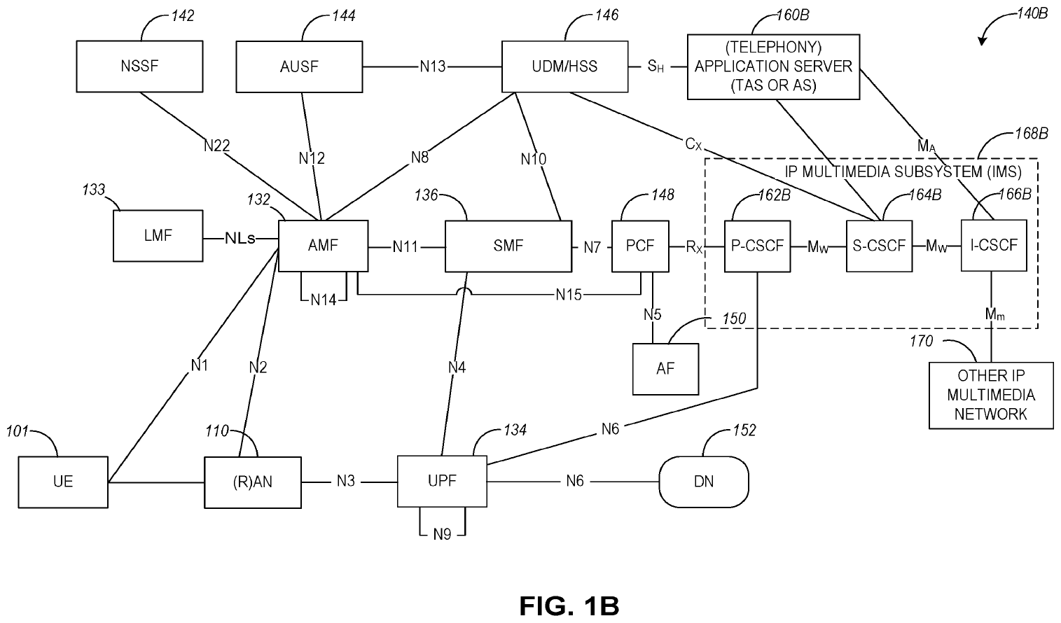

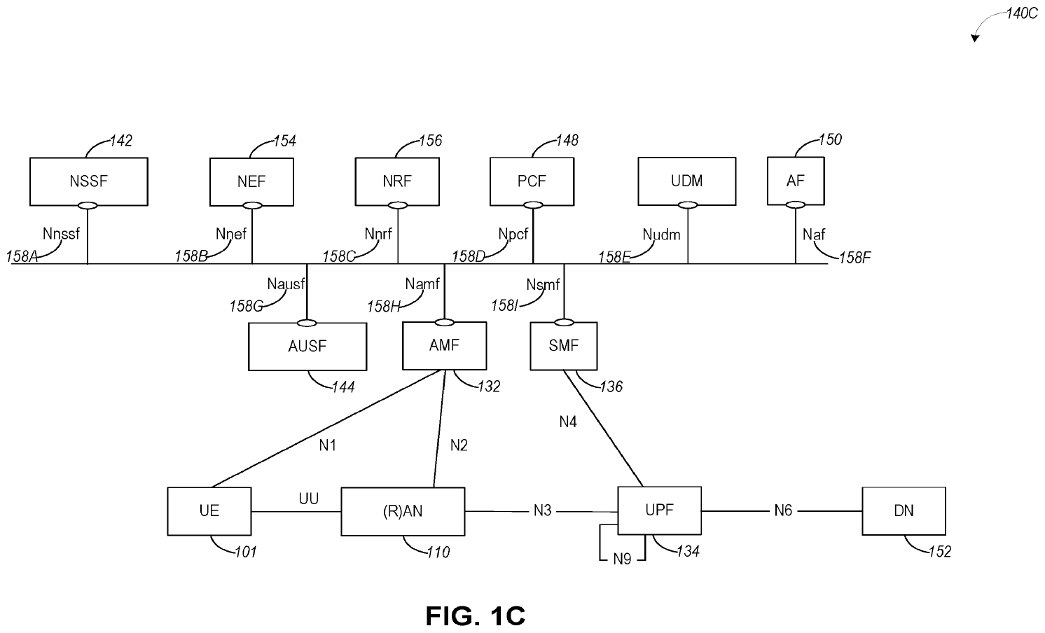

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHZ and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, the radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the next-generation radio access network (NG-RAN) 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The NG RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170, e.g. an IMS operated by a different network operator.

In some aspects, the UDM/HSS 146 can be coupled to an application server 160B, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

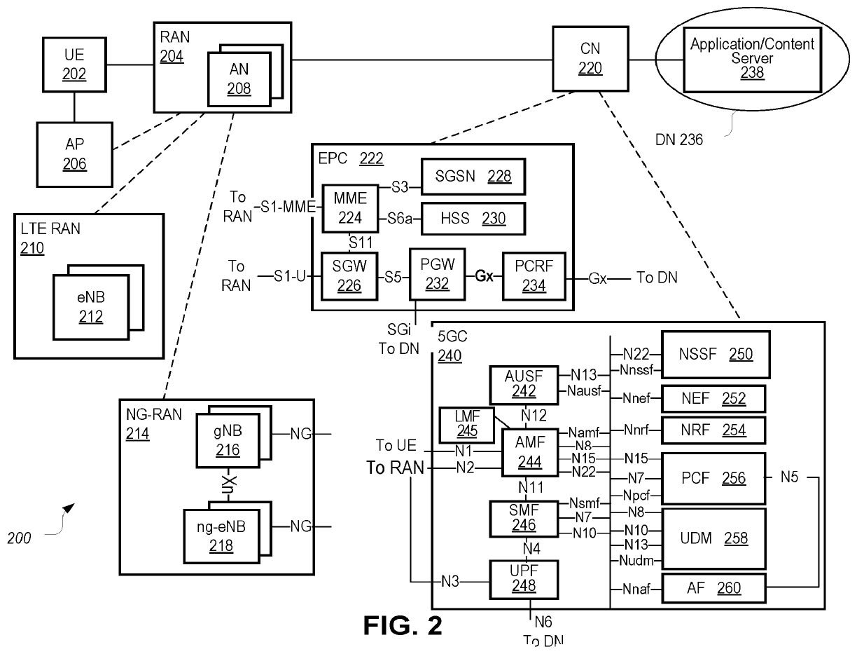

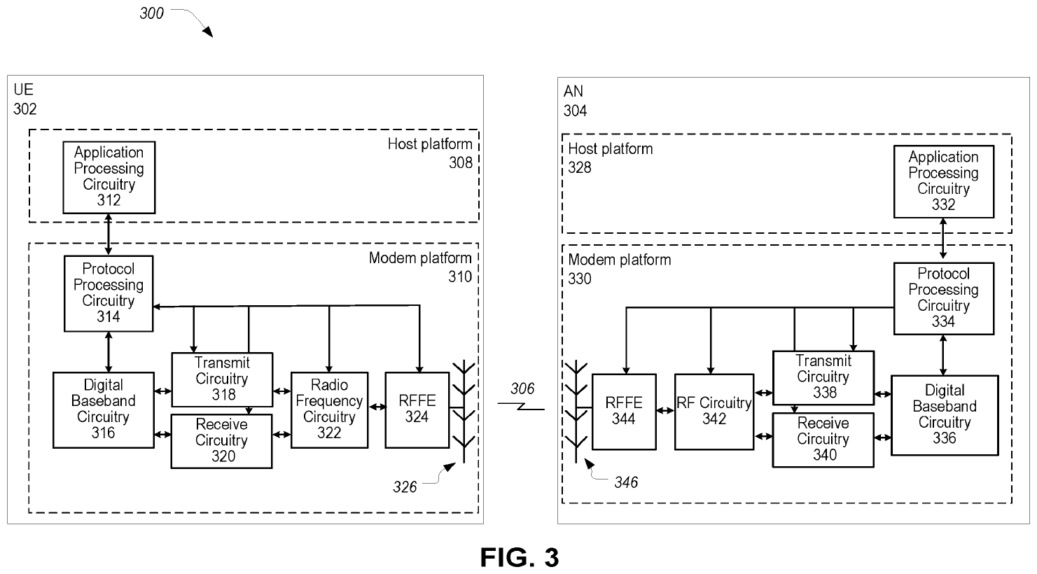

FIGS. 2-13 illustrate various systems, devices, and components that may implement aspects of disclosed embodiments in different communication systems, such as 5G-NR networks including 5G non-terrestrial networks (NTNs). UEs, base stations (such as gNBs), and/or other nodes (e.g., satellites or other NTN nodes) discussed herein can be configured to perform the disclosed techniques.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be but is not limited to, a smartphone, tablet computer, wearable computing device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, network 200 may include a plurality of UEs coupled directly with one another via a sidelink interface. The UEs may be M2M/D2D devices that communicate using physical sidelink channels such as but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 configured by the RAN 204 to utilize both cellular radio resources and WLAN resources.

The RAN 204 may include one or more access nodes, for example, access node (AN) 208. AN 208 may terminate air-interface protocols for the UE 202 by providing access stratum protocols including RRC, Packet Data Convergence Protocol (PDCP), Radio Link Control (RLC), MAC, and L1 protocols. In this manner, the AN 208 may enable data/voice connectivity between the core network (CN) 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low-power base station for providing femtocells, picocells, or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG, and a second AN may be a secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/SCells. Before accessing the unlicensed spectrum, the nodes may perform medium/carrier-sensing operations based on, for example, a listen-before-talk (LBT) protocol.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: sub-carrier spacing (SCS) of 15 kHz; CP-OFDM waveform for downlink (DL) and SC-FDMA waveform for uplink (UL); turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface but may connect with a UE via an LTE air interface. The gNB 216 and the ng-eNB 218 may connect over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS but may use PBCH DMRS for PBCH demodulation; PTRS for phase tracking for PDSCH and tracking reference signal for time tracking. The 5G-NR air interface may operate on FR1 bands that include sub-6 GHz bands or FR2 bands that include bands from 24.25 GHz to 52.6 GHz. The 5G-NR air interface may include a synchronization signal and physical broadcast channel (SS/PBCH) block (SSB) which is an area of a downlink resource grid that includes PSS/SSS/PBCH.

In some embodiments, the 5G-NR air interface may utilize BWPs (bandwidth parts) for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amounts of frequency resources (for example, PRBs) to support data transmission under different traffic loading scenarios. A BWP containing a smaller number of PRBs can be used for data transmission with a small traffic load while allowing power saving at the UE 202 and in some cases at the gNB 216. A BWP containing a larger number of PRBs can be used for scenarios with higher traffic loads.

The RAN 204 is communicatively coupled to CN 220 which includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be connected to the LTE radio network as part of the Enhanced Packet System (EPS) 222, which may also be referred to as an EPC (or enhanced packet core). The EPC 222 may include MME 224, SGW 226, SGSN 228, HSS 230, PGW 232, and PCRF 234 coupled with one another over interfaces (or “reference points”) as shown. Functions of the elements of the EPC 222 may be briefly introduced as follows.

The MME 224 may implement mobility management functions to track the current location of the UE 202 to facilitate paging, bearer activation/deactivation, handovers, gateway selection, authentication, etc.

The SGW 226 may terminate an S1 interface toward the RAN and route data packets between the RAN and the EPC 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track the location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable the transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 220 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for the provision of IMS services. The PGW 232 may be coupled with a PCRF 234 via a Gx reference point.

The PCRF 234 is the policy and charging control element of the LTE CN 220. The PCRF 234 may be communicatively coupled to the app/content server 238 to determine appropriate QoS and charging parameters for service flows. The PCRF 234 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for the authentication of UE 202 and handle authentication-related functionality. The AUSF 242 may facilitate a common authentication framework for various access types. In addition to communicating with other elements of the 5GC 240 over reference points as shown, the AUSF 242 may exhibit a Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to the management of a PDU session, and a PDU session or “session” may refer to a PDU connectivity service that provides or enables the exchange of PDUs between the UE 202 and the data network 236. The UPF 248 may act as an anchor point for intra-RAT and inter-

RAT mobility, an external PDU session point of interconnecting to data network 236, and a branching point to support multi-homed PDU sessions. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for the third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on the exposed capabilities of other NFs. This information may be stored at the NEF 252 as structured data, or a data storage NF using standardized interfaces. The stored information can then be re-exposed by the NEF 252 to other NFs and AFs, or used for other purposes such as analytics. Additionally, the NEF 252 may exhibit a Nnef service-based interface.

The NRF 254 may support service discovery functions, receive NF discovery requests from NF instances, and provide information on the discovered NF instances to the NF instances. NRF 254 also maintains information on available NF instances and their supported services. As used herein, the terms “instantiate,” “instantiation,” and the like may refer to the creation of an instance, and an “instance” may refer to a concrete occurrence of an object, which may occur, for example, during the execution of program code. Additionally, the NRF 254 may exhibit the Nnrf service-based interface.

The PCF 256 may provide policy rules to control plane functions to enforce them, and may also support a unified policy framework to govern network behavior. The PCF 256 may also implement a front end to access subscription information relevant to policy decisions in a UDR of the UDM 258. In addition to communicating with functions over reference points as shown, the PCF 256 exhibits an Npcf service-based interface.

The UDM 258 may handle subscription-related information to support the network entities' handling of communication sessions and may store the subscription data of UE 202. For example, subscription data may be communicated via an N8 reference point between the UDM 258 and the AMF 244. The UDM 258 may include two parts, an application front end, and a UDR. The UDR may store subscription data and policy data for the UDM 258 and the PCF 256, and/or structured data for exposure and application data (including PFDs for application detection, and application request information for multiple UEs 202) for the NEF 252. The Nudr service-based interface may be exhibited by the UDR to allow the UDM 258, PCF 256, and NEF 252 to access a particular set of the stored data, as well as to read, update (e.g., add, modify), delete, and subscribe to the notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re) selection and traffic routing. Based on operator deployment, when AF 260 is considered to be a trusted entity, the network operator may permit AF 260 to interact directly with relevant NFs. Additionally, the AF 260 may exhibit a Naf service-based interface.

The data network 236 may represent various network operator services, Internet access, or third-party services that may be provided by one or more servers including, for example, application/content server 238.

In some aspects, network 200 is configured for NR positioning using the location management function (LMF) 245, which can be configured as an LMF node or as functionality in a different type of node. In some embodiments, LMF 245 is configured to receive measurements and assistance information from NG-RAN 214 and UE 202 via the AMF 244 (e.g., using an NLs interface) to compute the position of the UE. In some embodiments, NR positioning protocol A (NRPPa) protocol can be used for carrying the positioning information between NG-RAN 214 and LMF 245 over a next-generation control plane interface (NG-C). In some embodiments, LMF 245 configures the UE 202 using LTE positioning protocol (LPP) (e.g., LPP-based communication link) via the AMF 244. In some aspects, NG RAN 214 configures the UE 202 using, e.g., radio resource control (RRC) protocol signaling over, e.g., LTE-Uu and NR-Uu interfaces. In some aspects, UE 202 uses the LTE-Uu interface to communicate with the ng-eNB 218 and the NR-Uu interface to communicate with the gNB 216. In some aspects, ng-eNB 216 and gNB 216 use NG-C interfaces to communicate with the AMF 244.

In some embodiments, the following reference signals can be used to achieve positioning measurements in NR communication networks: NR positioning reference signal (NR PRS) in the downlink and sounding reference signal (SRS) for positioning in the uplink. The downlink positioning reference signal (PRS) can be used as a reference signal supporting downlink-based positioning techniques. In some aspects, the entire NR bandwidth can be covered by transmitting PRS over multiple symbols that can be aggregated to accumulate power.

FIG. 3 schematically illustrates a wireless network 300 in accordance with various embodiments. The wireless network 300 may include a UE 302 in wireless communication with AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and the Internet (for example IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318 receive circuitry 320, RF circuitry 322, RFFE 324, and antenna panels 326 (referred to generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 302 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400. The one or more processors 410 may include, for example, a

processor 412 and a processor 414. The one or more processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the one or more processors 410 to perform any one or more of the methodologies discussed herein. The instructions 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of the one or more processors 410, the memory/storage devices 420, the peripheral devices 404, and the databases 406 are examples of computer-readable and machine-readable media.

For one or more embodiments, at least one of the components outlined in one or more of the preceding figures may be configured to perform one or more operations, techniques, processes, and/or methods as outlined in the example sections below. For example, baseband circuitry associated with one or more of the preceding figures may be configured to operate in accordance with one or more of the examples set forth below. For another example, circuitry associated with a UE, base station, satellite, network element, etc. as described above in connection with one or more of the preceding figures may be configured to operate in accordance with one or more of the examples set forth below in the example section.

The term “application” may refer to a complete and deployable package, or environment to achieve a certain function in an operational environment. The term “AI/ML application” or the like may be an application that contains some artificial intelligence (AI)/machine learning (ML) models and application-level descriptions. In some embodiments, an AI/ML application may be used for configuring or implementing one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience concerning some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principal component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution as well as any online learning if applicable). The ML host informs the actor about the output of the ML algorithm, and the actor decides on an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

The 5G NR specifications cater to the support of a diverse set of verticals and use cases, including enhanced mobile broadband (eMBB) as well as the newly introduced ultra-reliable low latency communications (URLLC) services. Support for Low Power Wide Area (LPWA) networks and use cases for extremely low complexity/cost devices, targeting extreme coverage, and ultra-long battery lifetimes, are expected to be served by MTC (Category M UEs) and NB-IoT (Category NB UEs) technologies.

Through the Rel-17 NR Reduced Capability (RedCap) work item, 3GPP has established a framework for enabling reduced capability NR devices suitable for a range of use cases, including industrial sensors, video surveillance, and wearables use cases, with requirements on low UE complexity and sometimes also on low UE power consumption. Enhancements can be considered to improve the support for the mentioned use cases and also to expand RedCap into a new range of use cases such as a smart grid.

RedCap devices can also be referred to as NR-Light devices, which can include wearable devices, industrial wireless sensors, and video surveillance devices, to name a few. Maximum device bandwidth for RedCap devices in FRI can be around 20 MHz and in FR2 can be around 100 MHz. In some aspects, RedCap devices can have a peak data rate of 150 Mbps in downlink and 50 Mbps in uplink. As used herein, the terms Reduced Bandwidth-RedCap devices and Further Reduced Capability (F-RedCap) devices are interchangeable and indicate RedCap devices with even further reduced bandwidth and data rates from the above-listed bandwidth and data rates of RedCap devices.

To further expand the market for RedCap use cases with relatively low cost/complexity, low energy consumption, and low data rate requirements, e.g., industrial wireless sensor network use cases, some further complexity reduction enhancements can be considered for Rel-18 RedCap UE. One potential enhancement for cost reduction is to reduce the bandwidth for Rel-18 RedCap UE. The disclosed techniques include enhancements for downlink (DL) reception and uplink (UL) transmission with reduced bandwidth. Rel-18 Redcap UE with limited bandwidth, e.g., 5 MHz, can be referred to as Reduced Bandwidth-RedCap (RBW-RedCap) UEs.

The disclosed techniques include systems and methods for DL reception with relaxed scheduling offset for RBW-RedCap UE and DL reception within semi-static/fixed frequency region for RBW-RedCap UE.

To reduce the complexity/cost, further reduction of bandwidth at least for base band processing may be considered. For example, a Rel-18 Redcap UE still supports 20 MHz bandwidth for RF, but only 5 MHz bandwidth for base band processing to reduce post-FFT data buffering, receiver processing block, LDPC decoding, and HARQ buffer. Throughout the present disclosure, 5 MHz bandwidth for base band processing allows two possible implementations: 1) the 5 MHz BW can be localized NBW PRBs; or, 2) the 5 MHz BW can be distributed NBW PRBs over 20 MHz BW. For example, NBW equals 25. The cost reduction ratio also depends on bandwidth restriction for all channels, or only for some channels, e.g., 20 MHz bandwidth for PDCCH and 5 MHz bandwidth for PDSCH/PUSCH, or 20 MHz bandwidth for broadcast channels while 5 MHz bandwidth for unicast channels.

For RBW-RedCap UEs, though examples are given based on 5 MHz bandwidth limitation, the same methods can be applicable for bandwidth limitation other than 5 MHz. Furthermore, although described in this disclosure using RBW-RedCap UEs, the same methods can apply to non-RBW-RedCap UEs as well.

The following configurations can be used for PDSCH reception with a relaxed scheduling offset.

For PDSCH reception, the UE expects the bandwidth to be no larger than a threshold Tfre, and UE expects that PDSCH is no earlier than PDCCH and the gap between PDSCH and PDCCH is no smaller than a threshold. Due to the gap between PDCCH and PDSCH, UE could firstly decode PDCCH without buffering other PRBs or symbols for potential PDSCH reception, and then, the UE could only buffer the allocated PRBs and symbols for the scheduled PDSCH reception after UE successfully decodes PDCCH. Therefore, some post-FFT data buffering can be saved. In one embodiment, the UE does not expect any DL channel/signal to occupy a bandwidth larger than Tfre. In another embodiment, the UE does not expect any DL channel/signal outside the frequency region for PDSCH reception. In another embodiment, the UE does not expect to receive any other DL channel/signal outside the frequency region in symbols for PDSCH. In another embodiment, the UE does not expect to receive PDCCH in symbols for PDSCH.

In some embodiments, PDSCH and PDCCH scheduling the PDSCH are in different slots. PDSCH starting in a later slot than PDCCH can be achieved according to at least one of the following ways:
(a) gNB ensures slot offset K0 larger than 0 in any row of the TDRA table configured in pdsch-TimeDomainAllocationList. In other words, UE is not expected to be configured with a TDRA table with K0=0 in any row. For example, pdsch-TimeDomainAllocationList is provided in PDSCH-ConfigCommon.
(b) gNB ensures the indicated K0>0 in the DCI scheduling PDSCH transmission. For example, the gNB may configure or use a TDRA table with K0=0 for some rows while K0>0 for other rows, but gNB can only use the row with K0>0 for specific UE type, e.g., RBW-RedCap UE. Then, UE is not expected to be indicated with a row with K0=0.
(c) In one example, for the case of a common TDRA table, e.g., TDRA table configured by PDSCH-ConfigCommon, gNB may configure some rows with K0=0 and other rows with K0>0 to serve different UEs with different UE capabilities. In such a case, gNB ensures proper K0 value is indicated for corresponding UE capabilities. For example, for Msg 4 PDSCH reception, gNB should indicate a row with K0>0 for RBW-RedCap UE, while gNB can indicate a row with K0=0 or K0>0 for Rel-17 Redcap UE or normal UE.
(d) In another example, gNB may separately configure a common TDRA table for RBW-RedCap UE and other UE respectively. RBW-RedCap UE is not expected to be configured with a common TDRA table with K0=0 in any row.

For the default TDRA table, at least one row includes K0>0, for RBW-RedCap UE.

In the legacy NR system, K0=0 is assumed for any row of the default PDSCH TDRA table as shown in Table 1 below.

The default PDSCH TDRA table can be revised to support RBW-RedCap UE. To support RBW-RedCap UE, in one example, the K0 value in some pre-defined rows is modified to support K0>0. In another example, the K0 value in all rows is modified to support K0>0. It is possible that, with the same row index, RBW-RedCap UE and non-RBW-RedCap UE interpret K0 values differently. Alternatively, a new default PDSCH TDRA table can be defined for RBW-RedCap UE. The K0 value in all rows in the new default PDSCH TDRA table can be expected to have K0>0. In another option, the K0 value (K0>0) may be explicitly indicated in the DCI, e.g., using a reserved bit field. In this case, indicated K0 value may override the K0 value determined from the TDRA table based on the following configurations:
(a) Slot delay Δ is applied in addition to the K0 value in the TDRA table, where Δ is configured by higher layers or predefined in the specification. In other words, for RBW-RedCap UE, the slot offset between PDCCH and PDSCH is K0+Δ.
(b) Slot delay Δ may depend on the location of the search space (SS). For example, for PDCCH in SS outside the first three symbols of the slot, slot delay Δ is incremented by one in addition to the pre-defined or configured value for slot delay Δ.

In some embodiments, slot delay Δ may be dynamically indicated in the DCI, e.g., using a reserved field. In this case, the slot offset between PDCCH and PDSCH is K0+Δ, Δ>0.

Whether existing or modified value for K0 is applied, or whether slot delay Δ is applied, can be explicitly or implicitly indicated by MIB, if applicable. For example, if MIB can indicate whether the network supports RBW-RedCap UE with limited bandwidth, UE can derive whether K0>0 or slot delay Δ can be applied.

If K0>0 is applied to a row in the PDSCH TDRA table, and if the PDCCH in SS set is outside the first three symbols of the slot, an additional slot in addition to the indicated K0 by the TDRA row may be applied for the scheduled PDSCH. In other words, the effective PDCCH-to-PDSCH scheduling delay is K0+1 slots.

In some embodiments, the 1st symbol of PDSCH starts no earlier than X symbols after the end of PDCCH scheduling the PDSCH. The value of X can be the same or different for broadcast PDSCH and unicast PDSCH. For example, a larger value of X can be considered for the broadcast PDSCH case, considering the worst case of different UE capabilities, while a smaller value of X for a unicast signal is possible depending on UE capability.

In some embodiments, the UE is not expected to receive a TDRA indicating a PDSCH starting symbol earlier than X symbols after the end of PDCCH scheduling the PDSCH. X can be sub-carrier spacing (SCS) specific, e.g., SCS for PDCCH, or SCS for PDCCH and PDSCH.

Alternatively, if the UE receives a TDRA indicating a PDSCH starting symbol earlier than X symbols after the end of PDCCH scheduling the PDSCH, the UE assumes PDSCH is in the next slot with indicated S (staring symbol) and L (duration).

In another embodiment, for all PDSCH receptions by RBW-RedCap UE, the same mechanism is applied to determine PDSCH time domain resource. In one example, a slot delay Δ is always applied in addition to the K0 value in a time-domain resource allocation (TDRA) table (e.g., Table 1 below) to determine the PDSCH slot. In another example, K0>0 is supported in at least some rows in the default TDRA table or the configured TDRA table, therefore, a slot delay Δ is not used for any TDRA table.

In some embodiments, for different PDSCH receptions by RBW-RedCap UE, a different mechanism may be applied to determine PDSCH time domain resource.

In some aspects, for PDSCH reception in a different state, a different mechanism is applied to determine PDSCH time domain resource. For example, for PDSCH in idle/inactive mode, slot delay Δ is applied in addition to the K0 value in the TDRA table to determine the PDSCH slot, while only K0 in the TDRA table is used to determine the PDSCH slot in the RRC connection mode.

In some aspects, for PDSCH reception using different TDRA tables, a different mechanism is applied to determine PDSCH time domain resource, e.g., for PDSCH reception based on default table, slot delay Δ is applied in addition to K0 value, and for PDSCH reception based on a configured table, K0 is applied and the UE is not expected to be indicated with K0=0. For example, if pdsch-TimeDomainAllocationList is not provided, slot delay Δ is applied in addition to the K0 value (K0=0) in the legacy default TDRA table to determine the PDSCH slot, otherwise, only K0 in the configured TDRA table is used to determine PDSCH slot for PDSCHs using the configured TDRA table and the UE is not expected to be indicated with K0=0. For PDSCH reception based on the default table, slot delay Δ is applied in addition to the K0 value. For another example, if pdsch-TimeDomainAllocationList is not provided by PDSCH-ConfigCommon but provided by PDSCH-Config, slot delay Δ is applied in addition to K0 value (K0=0) in legacy default TDRA table determines PDSCH slot for PDSCHs using the default table and only K0 in the configured TDRA table is used to determine PDSCH slot for PDSCHs using the configured TDRA table.

In another option, for PDSCH reception with different RNTI or scheduled by PDCCH in different SS, a different mechanism is applied to determine PDSCH time domain resource. For example, if pdsch-TimeDomainAllocationList is provided, for PDSCH except for the PDSCH with SI-RNTI scheduled by PDCCH in type 0 common search space (CSS), only K0 in TDRA table is used to determine PDSCH slot and the UE is not expected to be indicated with K0=0, otherwise, slot delay Δ is applied in addition to K0 value (K0=0) in legacy default TDRA table to determine PDSCH slot.

In another option, a unified framework can be used to handle the TDRA of the PDSCH scheduling, i.e., the effective scheduling delay is K0+Δ, where K0 is the scheduling offset defined by a row in the TDRA table, Δ can be larger than 0 or equal to 0 following a principle from the above options.

TABLE 1

| | dmrs- | PDSCH | | | |
|---|---|---|---|---|---|
| | TypeA- | mapping | | | |
| Row index | Position | type | K₀ | S | L |
| 1 | 2 | Type A | 0 | 2 | 12 |
| | 3 | Type A | 0 | 3 | 11 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2, 3 | Type B | 0 | 5 | 7 |
| 9 | 2, 3 | Type B | 0 | 5 | 2 |
| 10 | 2, 3 | Type B | 0 | 9 | 2 |
| 11 | 2, 3 | Type B | 0 | 12 | 2 |
| 12 | 2, 3 | Type A | 0 | 1 | 13 |
| 13 | 2, 3 | Type A | 0 | 1 | 6 |
| 14 | 2, 3 | Type A | 0 | 2 | 4 |
| 15 | 2, 3 | Type B | 0 | 4 | 7 |
| 16 | 2, 3 | Type B | 0 | 8 | 4 |

The following configurations can be used for PDSCH reception within semi-static/fixed frequency regions.

In some aspects, for PDSCH reception, the UE expects the bandwidth to be no larger than a threshold Tfre, and the UE expects that PDSCH is within a frequency region that is semi-statically determined or fixed according to a pre-defined rule. In this way, before a PDCCH is correctly decoded, the UE only needs to buffer the PRBs within the semi-static configured or fixed frequency region for RBW-RedCap UE which may potentially be used for PDSCH transmission. In some aspects, the UE does not expect any DL channel/signal outside the frequency region for PDSCH reception. In some aspects, the UE does not expect to receive any other DL channel/signal outside the frequency region in symbols for PDSCH. In some embodiments, the UE does not expect to receive PDCCH in symbols for PDSCH.

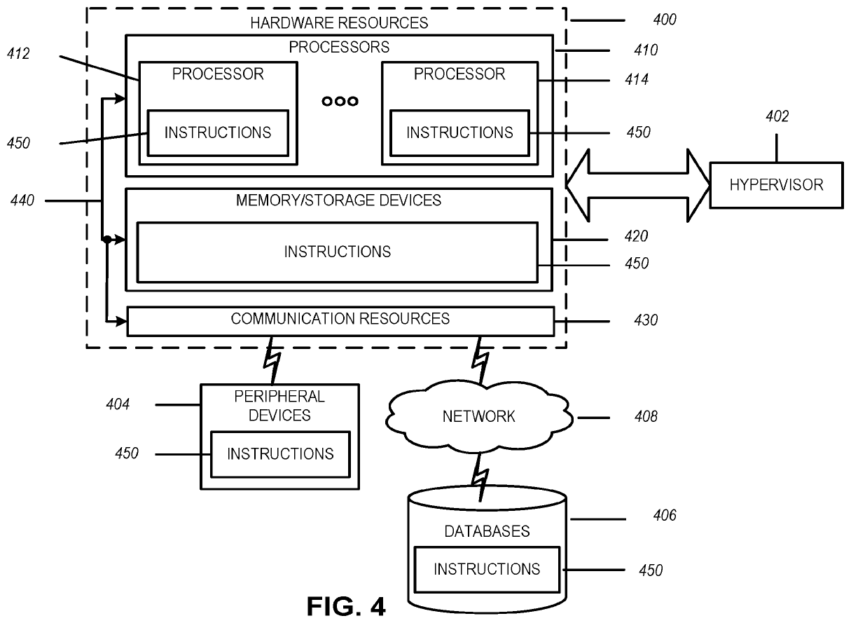

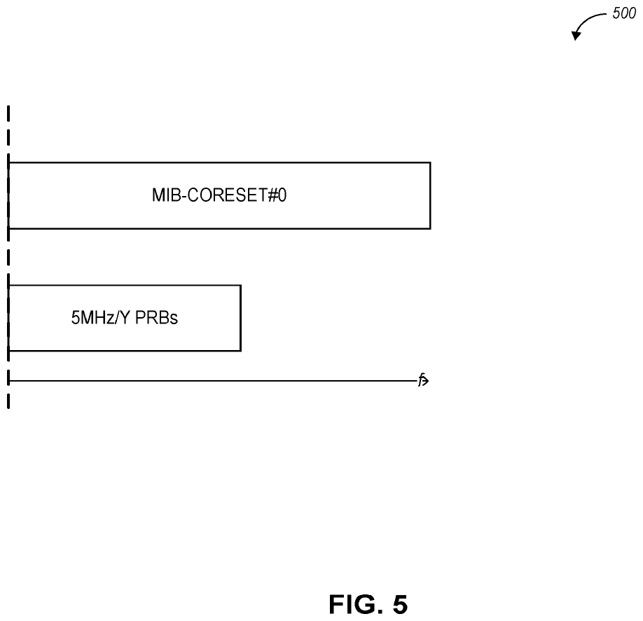

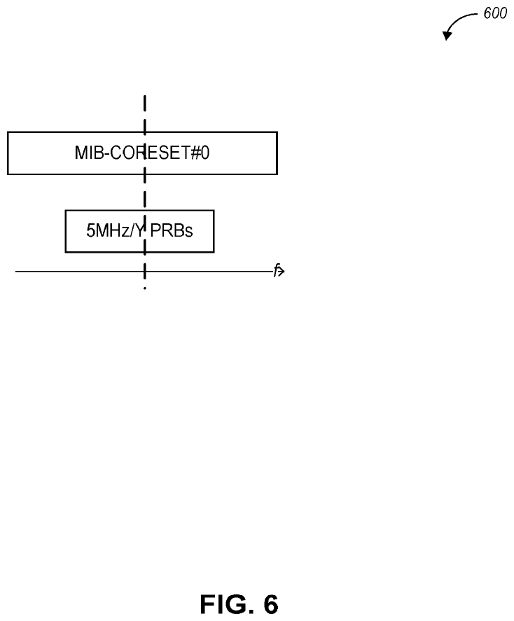

In the first option, the frequency region for PDSCH reception by RBW-RedCap UE is in Y consecutive PRBs starting from a reference point in the frequency domain. For example, the reference point is the lowest PRB for CORESET 0 for type 0 CSS as shown in FIG. 1-1 (MIB CORESET #0). For another example, the reference point is the ceiling or floor of Y/2 PRBs or Y/2-1 PRB to align the center location of MIB CORESET #0 and frequency region for PDSCH reception as shown in FIG. 5 and FIG. 6.

In a second option, the frequency region for PDSCH reception by RBW-RedCap UE is indicated by a PDCCH. For example, a new bit field is added in a PDCCH with CRC scrambled by SI-RNTI, or in a PDCCH in Type 0 CSS with CRC scrambled by SI-RNTI to indicate frequency region for potential PDSCH reception as shown below. One frequency region contains up to Y PRBs which is no larger than bandwidth threshold Tfre, e.g., 24 PRBs for SCS=15 kHz. Assuming the bandwidth of CORESET 0 for Type 0 CSS is 24*q PRBs where ‘q’ is a positive integer, the frequency region can be i*24+1˜(i+1)*24th PRB within 24*q PRBs, i-0, 1, . . . q−1. The frequency region indicator bit-width is ceiling (log 2 (q)). For another example, the frequency region is indicated by some reserved bits in a PDCCH with CRC scrambled by SI-RNTI, or in a PDCCH in Type 0 CSS with CRC scrambled by SI-RNTI. To indicate a frequency region, the gNB can indicate starting position and Y is fixed, or gNB can indicate both starting position and Y, or gNB can indicate Y and starting position is fixed. The starting position can be any PRBs within CORESET 0 bandwidth, or only in certain PRBs, e.g., assuming q non-overlapped candidate frequency regions within CORESET 0 bandwidth, the starting position is i*24th PRB, i=0, 1, . . . q−1.

In some embodiments, the frequency region is indicated by some of the bits in FDRA, e.g., LSB or MSB bit of FDRA, in a PDCCH with CRC scrambled by SI-RNTI, or in a PDCCH in Type 0 CSS with CRC scrambled by SI-RNTI.

In some embodiments, the following information is transmitted using the DCI format 1_0 with CRC scrambled by SI-RNTI: frequency domain resource assignment, time domain resource assignment, VRB-to-PRB mapping, modulation and coding scheme, redundancy version, system information indicator, frequency region indicator, and reserved bits.

In a third option, the frequency region for PDSCH reception other than SIB1 PDSCH by RBW-RedCap UE is indicated by SIB1. Then, SIBx (x>1), RAR PDSCH, Msg4 PDSCH can be received within the frequency region configured by SIB1.

In a fourth option, the frequency region for PDSCH reception by RBW-RedCap UE is indicated by dedicated RRC signaling.

For the above options, the frequency region consists of consecutive PRBs. Alternatively, the frequency region consists of non-consecutive PRBs.

If the gNB does not configure the frequency region for PDSCH reception, the frequency region is determined according to CORESET 0 location as in the first option.

For PDSCH reception by an RBW-RedCap UE, the same mechanism is applied to determine the frequency region for potential PDSCH reception. Alternatively, for PDSCH reception in different states, a different mechanism is applied to determine the frequency region for potential PDSCH reception. Alternatively, for PDSCH reception with different RNTI or scheduled by PDCCH in different SS, a different mechanism is applied to determine the frequency region for potential PDSCH reception. For example, for SIB1 PDSCH reception, the frequency region is determined according to CORESET 0 location or according to the frequency region indicator in PDCCH scheduling SIB1, and for other PDSCH reception before RRC connection setup, the frequency region is indicated by SIB1.

For the above aspects associated with PDSCH reception with relaxed scheduling offset and fixed/configured frequency region, different embodiments can be applied to different PDSCH reception by RBW-RedCap UE. For example, for SIB1 PDSCH reception, the UE determines the PDSCH reception slot according to K0 and slot delay Δ, without knowledge of frequency region. For other PDSCH reception, the UE determines the PDSCH reception slot according to K0 and configured frequency region.

For PUSCH transmissions, a similar mechanism can be applied to determine the frequency region for PUSCH transmission, e.g., SIB1 configures the frequency region for Msg3 PUSCH. Alternatively, the frequency region for the Msg 3 PUSCH is indicated by the random access response (RAR). A similar mechanism can be applied to determine the frequency region for PUCCH transmission.

In some embodiments, the frequency region for UL transmission only consists of contiguous PRBs. In some embodiments, the frequency region for UL transmission after the RRC connection set up only consists of distributed or contiguous PRBs, and the frequency region for UL transmission before the RRC connection set up only consists of contiguous PRBs. In some embodiments, the frequency region for UL transmission consists of contiguous or distributed PRBs. It is noted that consecutive PRBs at the different edges of UL BWP are considered distributed PRBs, e.g., if UL BWP consists of 48 PRBs, a frequency region consisting of 1st ˜ N1^{th} PRB and N2^{th} PRB˜48^{th} PRB is based on distributed PRBs.

In some embodiments, within the frequency region, RBW-RedCap UE does not expect allocated PRBs for a PUSCH transmission to be non-contiguous. In some aspects, within the frequency region, RBW-RedCap UE is not required to transmit a PUSCH if the allocated PRBs are non-contiguous. For example, if the same FDRA bit field is used for both RBW-RedCap and non-RBW-RedCap UE, and the PRBs for RBW-RedCap UE lead to PRBs on different edges of the frequency region, e.g., a PUSCH is on #23, #24, #0, #1 PRBs, the RBW-RedCap UE can skip the PUSCH transmission. Alternatively, the UE only transmits PUSCH on one edge of the frequency region.

In some aspects, the same frequency region for DL reception and UL transmission is assumed. In some aspects, the frequency region for DL reception and UL transmission can be separated and configured/determined.

In some aspects, in Type-2 random access procedure, an RBW-RedCap UE can expect that a PRACH preamble and an associated MsgA PUSCH are configured in the same frequency region.

A system and method to enhance the transmission for UE with reduced bandwidth (RBW-UE) include decoding, by the UE, a PDCCH. The method includes receiving, by the UE, a PDSCH starting after the end of the PDCCH, or located within a specific frequency region. The system and method include a configuration where the PDSCH starts in a slot n that is no earlier than the next slot to the end of the PDCCH. The system and method include a configuration where the PDSCH starts in a symbol X no earlier than the N symbol gap after the end of the PDCCH. The system and method include a configuration where the slot n is determined by the slot of PDCCH, slot-level offset K0, and additional delay Δ. The system and method include a configuration where the slot n is determined by the slot of PDCCH and slot-level offset K0, wherein the K0>0. The system and method include a configuration where the K0 in at least one row of the default TDRA table or configured table is larger than 0. The system and method include a configuration where the PDSCH starting symbol or slot is indicated by the PDCCH. The system and method include a configuration where the PDSCH is located within a specific frequency region, where the frequency region is with a specifically limited bandwidth. The system and method include a configuration where the starting location of the specific frequency region is pre-defined within CORESET 0 bandwidth configured by MIB. The system and method include a configuration where the starting location of the specific frequency region is indicated by the PDCCH. The system and method include a configuration where the PDSCH starting symbol/slot or the starting location of the specific frequency region is indicated by the reserved bit field in the PDCCH.

To further expand the market for RedCap use cases with lower cost/complexity, lower energy consumption, and lower data rate requirements, e.g., industrial wireless sensor network use cases, some further complexity reduction enhancements can be considered for Rel-18 RedCap UEs. One potential enhancement to reduce cost is to reduce the bandwidth for Rel-18 RedCap UE.

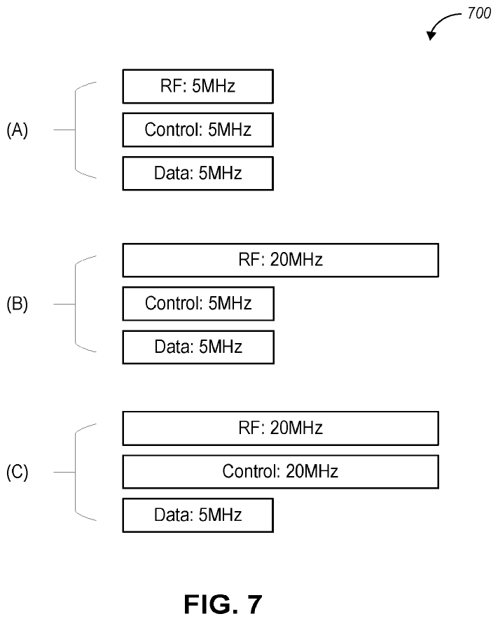

FIG. 7 illustrates one example of bandwidth options of RBW-RedCap UEs that we refer to as Reduced Bandwidth-RedCap (RBW-RedCap) UEs herein. In Option A, both radio frequency (RF) and baseband (BB) can be reduced to 5 MHz which maximizes potential complexity reduction. In Option B, the BB is reduced to 5 MHz while the RF is still 20 MHz since the complexity reduction by BW reduction of RF is not significant. In Option C, it keeps both the RF and control channel/signal in the BB as 20 MHz and only the data channel in BB can be reduced to 5 MHz. Though Option C provides the least complexity reduction, it allows more flexible scheduling which minimizes the changes to existing NR operations.

The disclosed techniques include enhancements for control channel transmission for UEs with reduced bandwidth. In particular, the disclosed techniques include CORESET bundling/repetition and PDCCH reception within semi-static/fixed frequency regions in a CORESET.

To reduce the complexity for a RedCap UE (RBW-RedCap UE), further reduction of bandwidth at least for the data channel of the base band (BB) processing can be considered. An RBW-RedCap UE only has a bandwidth capability of 5 MHz which may include 24 PRBs in a CORESET. Correspondingly, the maximum number of CCEs in the CORESET is 12 assuming a maximum duration of 3 OFDM symbols for the CORESET.

The following configurations can be used for CORESET bundling/repetition.

Since a maximum of 12 CCEs can be supported in a CORESET for an RBW-RedCap UE, the PDCCH aggregation level (AL) 16 is not applicable which results in even worse coverage. To compensate for the coverage lose due to reduced AL, additional time resources can be allocated for a PDCCH candidate.

In some embodiments, a CORESET is still limited to up to 3 OFDM symbols, and a PDCCH candidate can be repeatedly mapped to the same set of CCEs on two or more occasions of the same CORESET. The REG bundles are ordered within a CORESET. The CCE-to-REG mapping is still defined within a CORESET. For example, the same scheme as the CCE-to-REG mapping defined in section 7.3.2.2 in TS38.211 can be reused. The same CCE-to-REG mapping applies to each occasion of the CORESET.

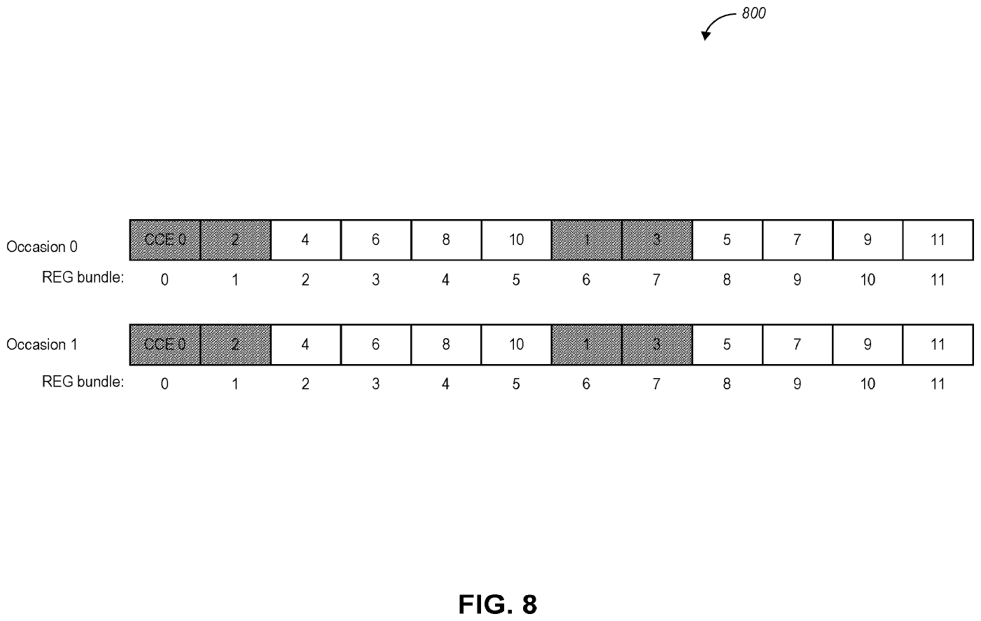

FIG. 8 illustrates diagram 800 of one example of the same CCE-to-REG mapping for the two repetitions of a CORESET. It is assumed that the CORESET has 24 PRBs and 3 OFDM symbols which results in 12 CCEs. In FIG. 8, a PDCCH candidate with AL=8 will be mapped to CCE 0/1/2/3 on the two occasions.

In some embodiments, a CORESET is still limited to up to 3 OFDM symbols, and a PDCCH candidate can be mapped to the same set of CCEs on two or more occasions of the same CORESET with different CCE-to-REG mapping on each occasion. The REG bundles are ordered within a CORESET. The CCE-to-REG mapping is still defined within a CORESET.

In some embodiments, the same scheme as the CCE-to-REG mapping defined in section 7.3.2.2 in TS38.211 can be reused with parameter n_{shift} being replaced by n_{shift}+Δₖ for occasion k, Δₖ≥0, k=0, 1, . . . , of the two or more occasions. The occasion 0 may have Δₖ₌₀=0 which means the predefined or configured n_{shift} applies for the CCE-to-REG mapping of the CORESET.

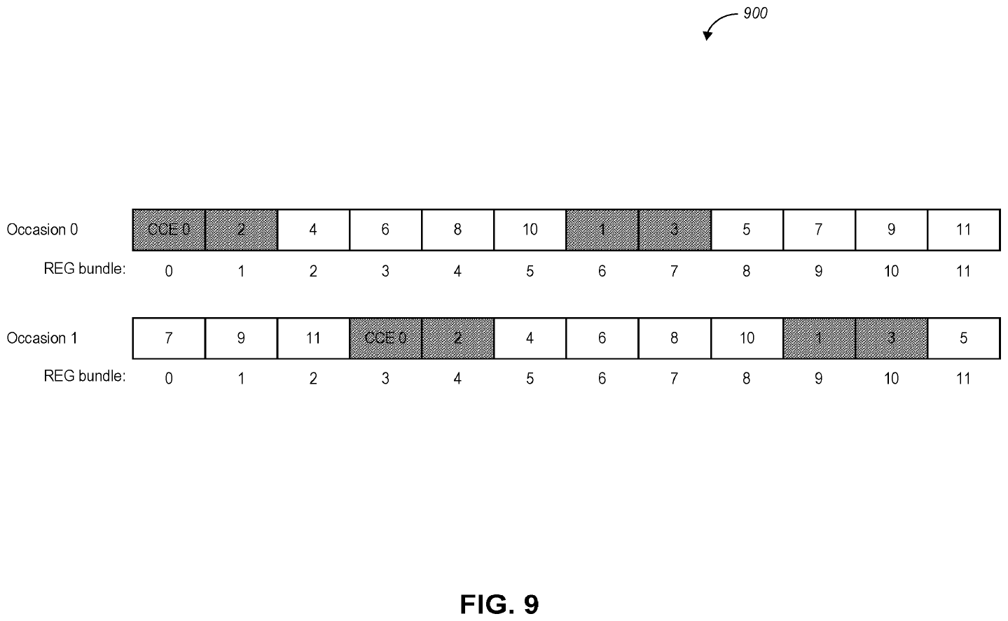

FIG. 9 illustrates diagram 900 of one example of the CCE-to-REG mapping for the two occasions of a CORESET. It can be assumed that the CORESET has 24 PRBs and 3 OFDM symbols which results in 12 CCEs. In FIG. 9, CCE-to-REG mapping with n_{shift}+Δₖ=0 applies to the first occasion of the CORESET. CCE-to-REG mapping with n_{shift}+Δₖ=3 applies to the second occasion of the CORESET. A PDCCH candidate with AL-8 will be to CCE 0/1/2/3 on the two occasions. A better frequency diversity gain can be obtained by mapping the CCEs into 4 different PRB positions.

In another option, the non-interleaved CCE-to-REG mapping may be used with an offset Δₖ for occasion k, Δₖ≥0, k=0, 1, . . . , of the two or more occasions. The occasion 0 may have Δₖ₌₀=0 which is to apply the non-interleaved CCE-to-REG mapping defined in section 7.3.2.2 in TS38.211 to the CORESET, i.e., the CCE x mapped to REG bundle x, f(x)=x. In general, for an occasion k, the CCE x mapped to REG bundle x, f(x)=(x+Δₖ) mod N_{REGBundle}^{CORESET}. Frequency diversity gain for PDCCH detection can be achieved with the non-interleaved CCE-to-REG mapping.

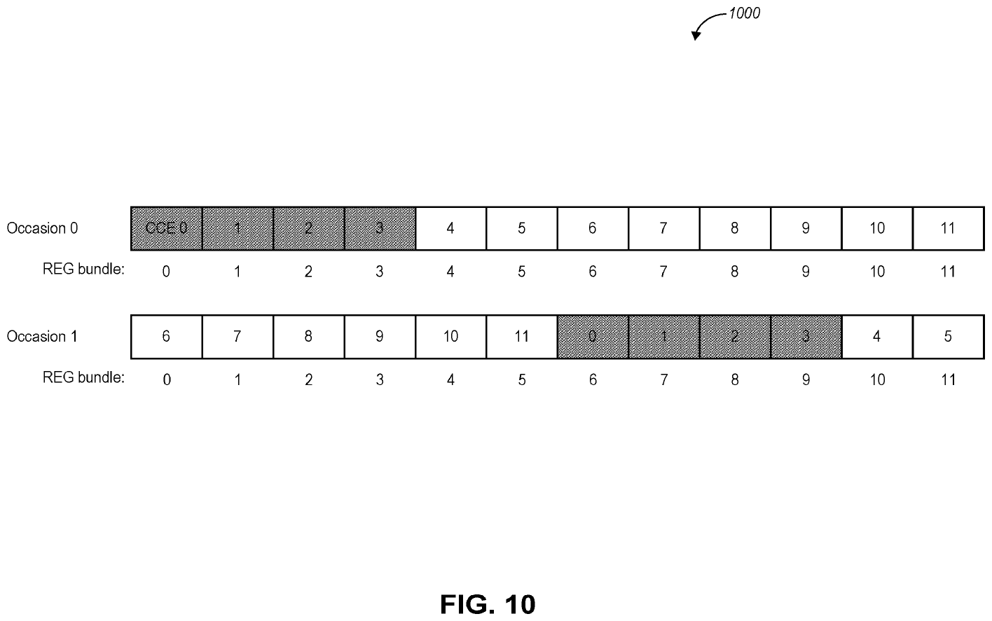

FIG. 10 illustrates diagram 1000 of one example of the CCE-to-REG mapping for the two occasions of a CORESET. It can be assumed that the CORESET has 24 PRBs and 3 OFDM symbols which results in 12 CCEs. In FIG. 10, non-interleaved CCE-to-REG mapping with Δₖ₌₀=0 applies to occasion 0, while non-interleaved CCE-to-REG mapping with Δₖ₌₀=6 applies to occasion 1, i.e. f(x)=(x+6) mod 12. A PDCCH candidate with AL=8 will be to CCE 0/1/2/3 on the two occasions.

In some embodiments, a CORESET is still limited to up to 3 OFDM symbols, and a PDCCH candidate can be mapped to the CCEs on two or more occasions of the same CORESET. The REG bundles on two or multiple occasions can be consecutively numbered. Then, a CCE-to-REG mapping can be defined across two or multiple occasions. The same scheme as the CCE-to-REG mapping defined in section 7.3.2.2 in TS38.211 can be reused.

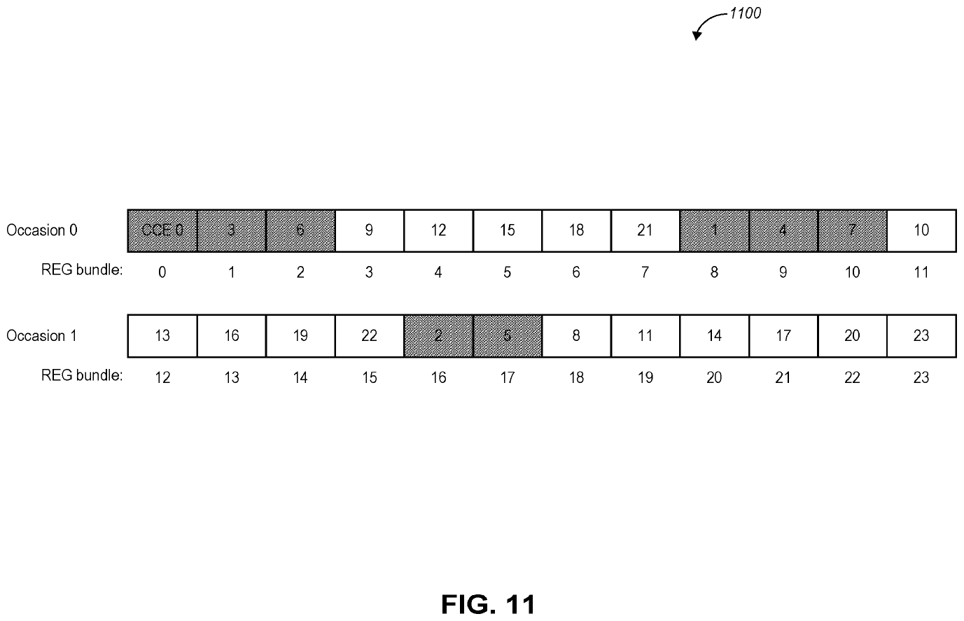

In some embodiments, the REG bundles in occasion k of the two or more occasions can be numbered from k·N_{REGBundle}^{CORESET} to k·N_{REGBundle}^{CORESET}+N_{REGBundle}^{CORESET}−1 in ascending order of the PRB index, where N_{REGBundle}^{CORESET} is the number of REG bundles in a CORESET. FIG. 11 illustrates diagram 1100 of one example of the CCE-to-REG mapping across two occasions of the same CORESET with parameter R=3. It can be assumed that the CORESET has 24 PRBs and 3 OFDM symbols which results in 12 CCEs. In FIG. 11, the CCE-to-REG mapping is done across the two occasions as if a CORESET with 24 REG bundles. The 8 CCEs for a PDCCH candidate with AL=8 are shown in FIG. 5, which achieves a good frequency diversity.

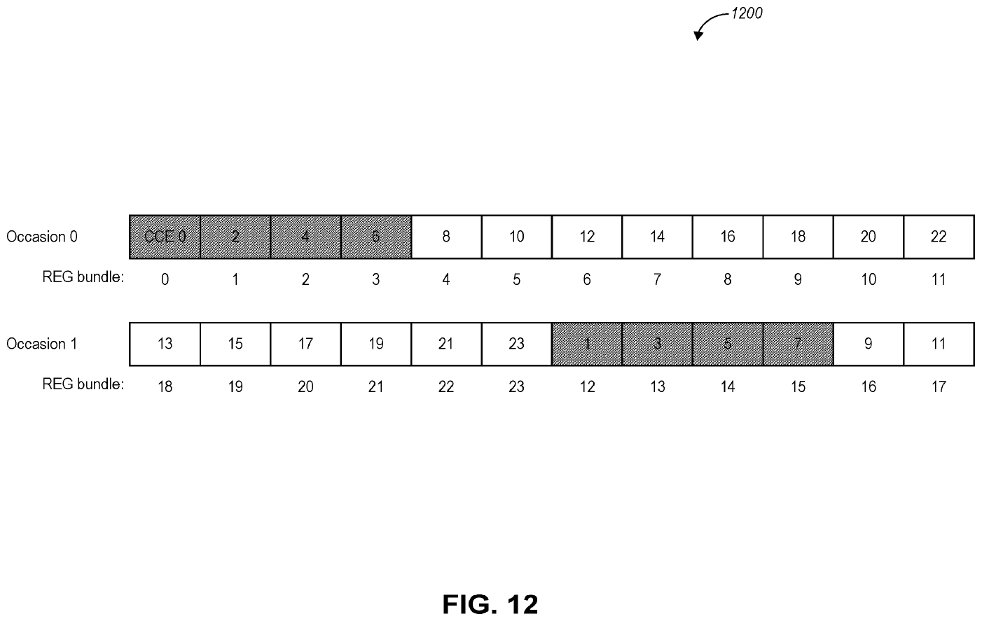

In some embodiments, the REG bundles in occasion k of the two or more occasions can be numbered as k·N_{REGBundle}^{CORESET}+(oₖ+i) mod N_{REGBundle}^{CORESET}, i=0, 1, . . . . N_{REGBundle}^{CORESET}−1 in ascending order of the PRB index, where N_{REGBundle}^{CORESET} is the number of REG bundles in a CORESET. For example, for the CCE-to-REG mapping across two occasions of the same CORESET with parameter R=2, if the CORESET has 24 PRBs and 3 OFDM symbols which results in 12 CCEs, the values oₖ can be 0, 6 for occasions 0, 1 respectively. FIG. 12 illustrates diagram 1200 of one example of the REG bundle ordering and the CCE-to-REG mapping across two occasions of the same CORESET with parameter R=2. It can be assumed that the CORESET has 24 PRBs and 3 OFDM symbols which results in 12 CCEs. In FIG. 12, the CCE-to-REG mapping is done across the two occasions as if a CORESET with 24 REG bundles. The 8 CCEs for a PDCCH candidate with AL=8 are shown in FIG. 12, which achieves a good frequency diversity.

In some embodiments, a CORESET is still limited to up to 3 OFDM symbols, and two or more occasions using the same or different CORSETs may be bounded to support larger PDCCH AL. The CCE-to-REG mapping is still defined within a CORESET. K PDCCH candidates respectively from the K occasions of CORESET are bundled into a bundled PDCCH candidate.

According to section 10.1 in TS 38.213, for a search space set s associated with CORESET p, the CCE indexes for aggregation level L corresponding to PDCCH candidate m_{s,n}_{_{CI}}^{(L)} of the search space set in the slot n_{s,f}^{μ} for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) \text{} mod [ {N}_{CCE , p} / L ] \} + i ,$$

where for any CSS,

$${Y}_{p , {n}_{s , f}^{μ}} = 0 ;$$

### for a USS,

$${Y}_{p , {n}_{s , f}^{μ}} = ( {A}_{p} \cdot {Y}_{p , {n}_{s , f}^{μ − 1}} ) \text{} mod D ,$$

Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is the number of CCEs, numbered from 0 to N_{CCE,p}−1, in CORESET p and, if any, per RB set; n_{CI} is the carrier indicator field value if the UE is configured with a carrier indicator field by CrossCarrierSchedulingConfig for the serving cell on which PDCCH is monitored; otherwise, including for any, CSS, n_{CI}=0; m_{s,n}_{_{CI}}^{(L)}=0, . . . , M_{s,n}_{_{CI}}^{(L)}−1, where M_{s,n}_{_{CI}}^{(L)} is the number of PDCCH candidates the UE is configured to monitor for aggregation level L of a search space set s for a serving cell corresponding to n_{CI}; for any CSS, M_{s,max}^{(L)}=M_{s,0}^{(L)}; for a USS, M_{s,max}^{(L)} is the maximum of M_{s,n}_{_{CI}}^{(L)} over all configured n_{CI} values for a CCE aggregation level L of search space set s; and the RNTI value used for n_{RNTI} is the C-RNTI.

With the above formula, for the multiple MOs in the same slot for a SS set, the same PDCCH candidate to CCE mapping applies.

In some embodiments, the K PDCCH candidates that are bundled have the same AL and the same PDCCH candidate index in the SS set in the respective occasions of the CORESETs. With the above formula in section 10.1 in TS 38.213, if the occasions of a CORESET are in different slots, the PDCCH candidate with the same index may be mapped to different CCEs due to the randomization provided by

$${Y}_{p , {n}_{s , f}^{μ}} ,$$

which provides frequency diversity gain.

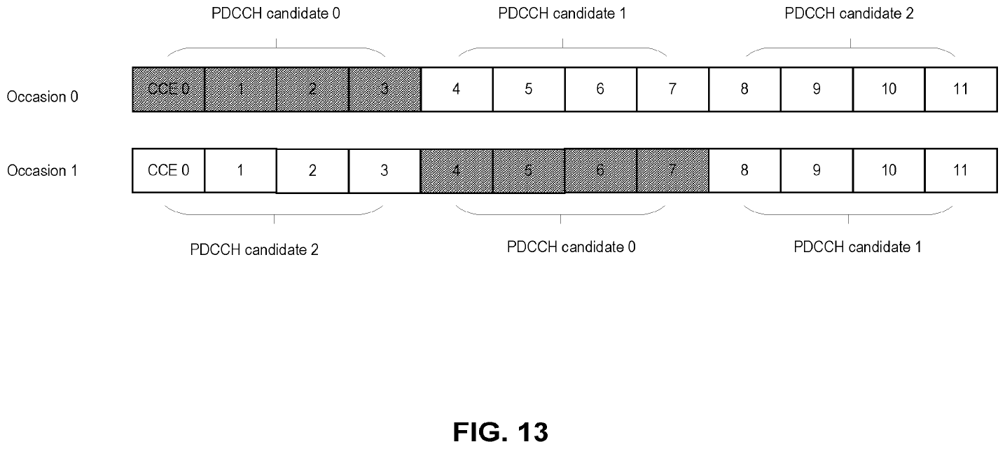

FIG. 13 illustrates diagram 1300 of one example of bundling two PDCCH candidates in two occasions to generate a PDCCH with larger AL. The CORSET has 12 CCEs, hence it has 3 PDCCH candidates with AL=4. The 3 PDCCH candidates with index 0, 1, or 2 in occasion 0 may be respectively mapped CCE 0-3, 4-7, or 8-11. On the other hand, the 3 PDCCH candidates with index 0, 1, or 2 in occasion 1 may be respectively mapped CCE 4-7, 8-11, or 0-3. The PDCCH candidate 0 in the two occasions can be bunded into a PDCCH candidate with AL=8. Though non-interleaved CCE-to-REG mapping is assumed in the figure, the same operation applies to the case of interleaved CCE-to-REG mapping.

In some aspects, the K PDCCH candidates that are bundled have the same AL and a predefine rule is used to determine the PDCCH candidate index in respective CORESET. In some aspects, the bundled PDCCH candidate with index j can be the PDCCH candidate (j+k)mod N_{AL} in occasion k, where N_{AL} is the total number of PDCCH candidates with the AL in occasion k. Alternatively, the PDCCH candidate index in respective CORESET that are bundled can be configured by high layer signaling. By this option, the bundled PDCCH candidate can be mapped to different CCEs in different MOs in the same slot for a SS set for frequency diversity.

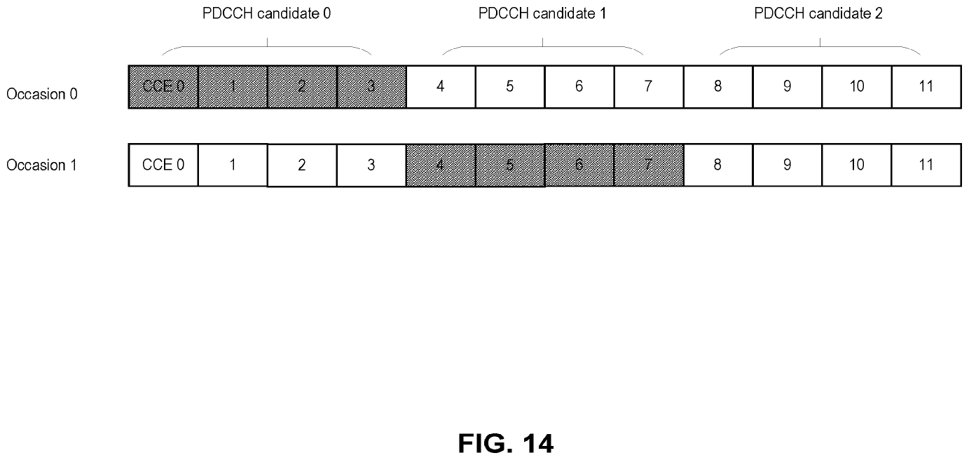

FIG. 14 illustrates diagram 1400 of one example of bundling two PDCCH candidates in two occasions to generate a PDCCH with larger AL. The CORSET has 12 CCEs, hence it has 3 PDCCH candidates with AL=4. The 3 PDCCH candidates respectively consist of CCE 0-3, 4-7, and 8-11. The PDCCH candidate 0 in occasion 0 and PDCCH candidate 1 in occasion 1 can be bundled to generate a PDCCH candidate with AL=8. Though non-interleaved CCE-to-REG mapping is assumed in the figure, the same operation applies to the case of interleaved CCE-to-REG mapping.

In some embodiments, the K PDCCH candidates that are bundled may have different AL. The AL and index of a PDCCH candidate in respective CORESET that are bundled can be predefined or configured by high-layer signaling.

In some embodiments, a CORESET can be configured with up to N_{symb}^{CORESET} OFDM symbols, N_{symb}^{CORESET}>3. For example, N_{symb}^{CORESET} equals to 6. A REG bundle can include the same PRB in the 6 OFDM symbols, which corresponds to one CCE.

In some embodiments, REG bundleⁱ is defined as REGs {iL, iL+1, . . . , iL+L−1} where L=6 is the REG bundle size, i=0, 1, . . . , N_{REG}^{CORESET}/L−1, and N_{REG}^{CORESET}=N_{RB}^{CORESET} N_{symb}^{CORESET} is the number of REGs in the CORESET. CCE^{j} consists of REG bundles {f(6j/L), f(6j/L+1), . . . , f(6j/L+6/L−1)} where f(·) is an interleaver. For non-interleaved CCE-to-REG mapping, L=6 and f(x)=x

For interleaved CCE-to-REG mapping, L=6. The interleaver is defined by f(x)=(rC+c+n_{shift}) mod (N_{REG}^{CORESET}/L), x=cR+r, r=0, 1, . . . , R−1, c=0, 1, . . . , C−1, C=N_{REG}^{CORESET}/(LR), where R∈{2,3,6}.

N_{RB}^{CORESET} is given by the higher-layer parameter frequencyDomainResources, interleaved or non-interleaved mapping is given by the higher-layer parameter cce-REG-MappingType, R is given by the higher-layer parameter interleaverSize, and n_{shift}∈{0, 1, . . . , 274} is given by the higher-layer parameter shiftIndex if provided, otherwise n_{shift}=N_{ID}^{cell}.

The following describes configurations for PDCCH reception within a semi-static/fixed frequency region in a CORESET.

If a CORESET is configured in a bandwidth that is larger than the bandwidth of RBW-RedCap UE, the RBW-RedCap UE may support doing PDCCH monitoring in a frequency region in the CORESET. The bandwidth of the frequency region is determined by the bandwidth of the RBW-RedCap UE. For PDCCH reception, the RBW-RedCap UE expects the bandwidth to be no larger than a threshold Tfre, and the UE expects that PDCCH is within a frequency region that is semi-statically determined or fixed according to a pre-defined rule. The bandwidth may consist of consecutive PRBs. Alternatively, the bandwidth may consist of non-consecutive PRBs.

In some embodiments, the frequency region for PDCCH reception by RBW-RedCap UE is in Y consecutive PRBs starting from a reference point in the frequency domain. One frequency region contains up to Y PRBs which is no larger than bandwidth threshold Tfre, e.g., 24 PRBs for SCS=15 kHz. For another example, the reference point is Y/2 PRBs or Y/2-1 PRB to align the center location of MIB CORESET #0 and frequency region for PDCCH reception for RBW-RedCap UE. For another example, the reference point is Noffset PRB offset to the lowest PRB of MIB CORESET #0. Noffset may be predefined or determined by the parameter n_{shift}. Noffset can be n_{shift} mod (N_{CCE}^{CORESET}/2), N_{CCE}^{CORESET} is the total number of CCEs in MIB CORESET #0.

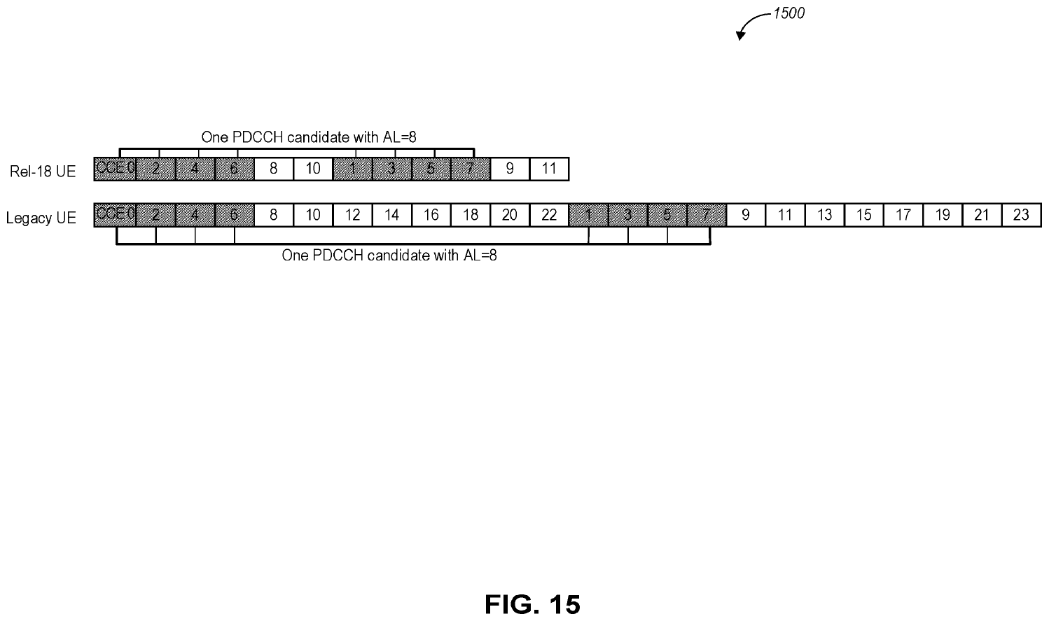

In one option, RBW-RedCap UE with reduced bandwidth assumes CCE-to-REG mapping is performed within the frequency region. For example, CORESET #0 consists of 48 PRBs and 3 symbols, i.e., 24 CCEs. The frequency region is the lowest 24 PRBs starting from the first PRB of CORESET #0. RBW-RedCap UE with reduced bandwidth assumes CCE-to-REG mapping is within these 24 PRBs (12 CCEs), while legacy UE assumes CCE-to-RE mapping is within CORESET 0 48 PRBs (24 CCEs), as shown in diagram 1500 of FIG. 15.

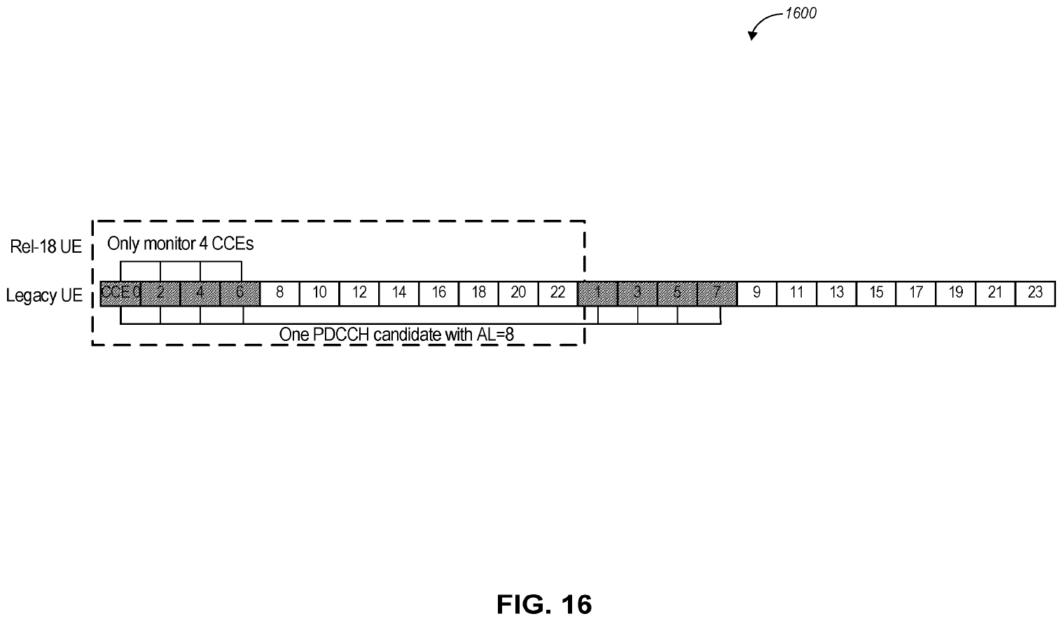

In another option, both legacy UE and RBW-RedCap UE with reduced bandwidth assumes CCE-to-REG mapping is performed within CORESET 0 bandwidth, but the RBW-RedCap UE only attempts to decode partial PDCCH candidate within the frequency region. As shown in diagram 1600 of FIG. 16, the UE may only receive the 4 CCEs with indexes 0, 2, 4, and 6 of a PDCCH candidate with AL=8.

To compensate for the coverage lose due to the reduced aggregation level, additional symbols can be allocated for PDCCH reception. For example, additional N symbols can be allocated so that the RBW-RedCap UE can use N symbols in CORESET 0 and additional N symbols to receive PDCCH, where N is the number of symbols for CORESET 0. The location of additional N symbols can be derived by the location of CORESET 0, e.g., starting from the next symbol after the end of CORESET 0. Alternatively, the additional N symbols are in the next PDCCH monitoring occasion after a CORESET 0 associated with an SSB. For example, the N symbols for CORSET #0 and the additional N symbols are respectively in slots n0 and n0+1 which are determined by an SSB index. In general, the PDCCH transmissions in the frequency region in the symbols of CORESET 0 and the additional symbols can be treated by CORESET repetition/bundling or as a CORESET with an increased number of symbols, which are disclosed in the above embodiments.

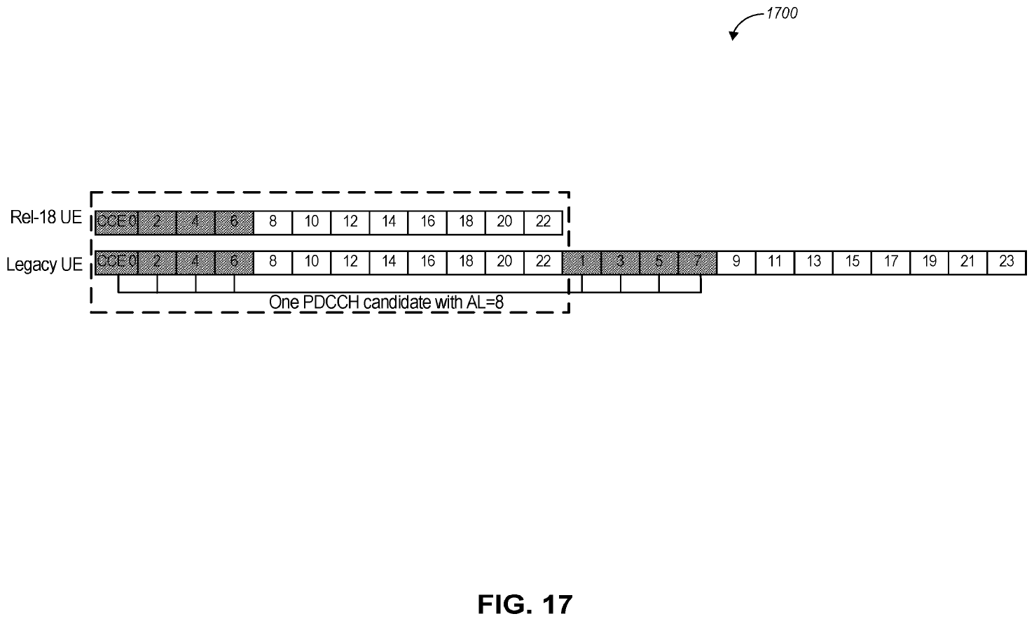

In one example, the same CCE-to-REG mapping is applied for both CORESET 0 N symbols and additional N symbols respectively in the overlapping PRBs of the frequency region for PDCCH reception by RBW-RedCap UE, which is effectively PDCCH repetition. As shown in diagram 1700 of FIG. 17, there are a total of 6 symbols for PDCCH reception by RBW-RedCap UE. In the case of a PDCCH candidate with AL=8, UE receives 4 CCEs in every 3 symbols. Both legacy UE and Rel-18 UE can share the same 4 CCEs of a PDCCH, i.e. CCE 0, 2, 4, and 6 in the first N symbols. In another example, CCE-to-REG mapping is applied among 2N symbols. In other words, one REG bundle maps onto 2N symbols, thus a PDCCH candidate is rate matched in 2N symbols rather than rate matching in each Nth symbol plus a repetition.

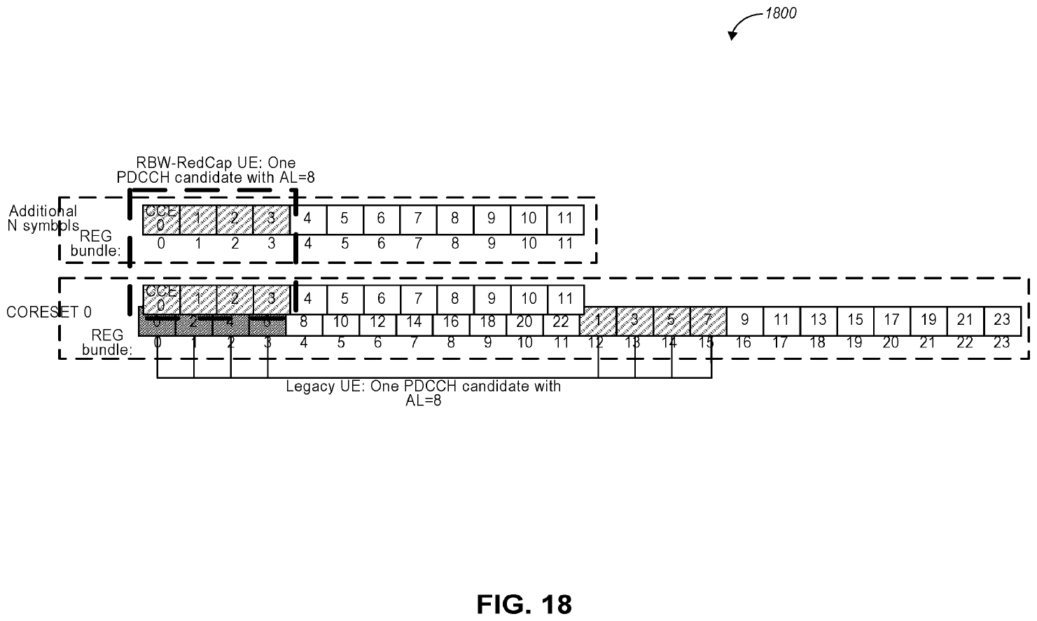

Alternatively, the CCE-to-REG mapping is done in the frequency region of 5 MHz in CORESET 0. As shown in diagram 1800 of FIG. 18, it can be assumed to apply non-interleaved CCE-to-REG mapping in the frequency region. For a PDCCH candidate with AL=8, UE receives 4 CCEs with the same index of 0,1,2,3 in every 3 symbols. Alternatively, the non-interleaved CCE-to-REG mapping may be used with an offset Δₖ in the additional N symbols.

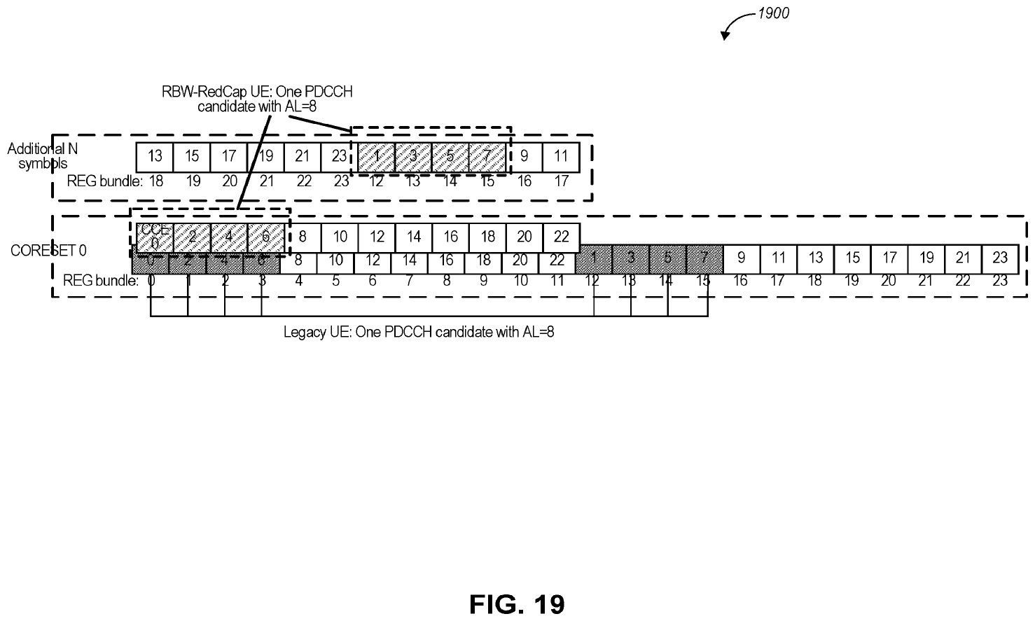

Alternatively, in the frequency region for PDCCH reception in the additional N symbols, the REGs are continuously indexed after the last REG index in the frequency region for PDCCH reception in CORESET #0 with an offset, e.g., the offset=6 CCEs. As shown in diagram 1900 of FIG. 19, the 12 CCEs are numbered 0, 2 . . . 22 in the frequency region in the CORESET #0. The 12 CCEs in the frequency region in the additional N symbols are indexed by 13, 15, . . . 23 followed by 1, 3, . . . 11. A PDCCH candidate for RBW-RedCap UE can be mapped to the CCEs with the same CCE index as a PDCCH with the same AL in CORESET #0.

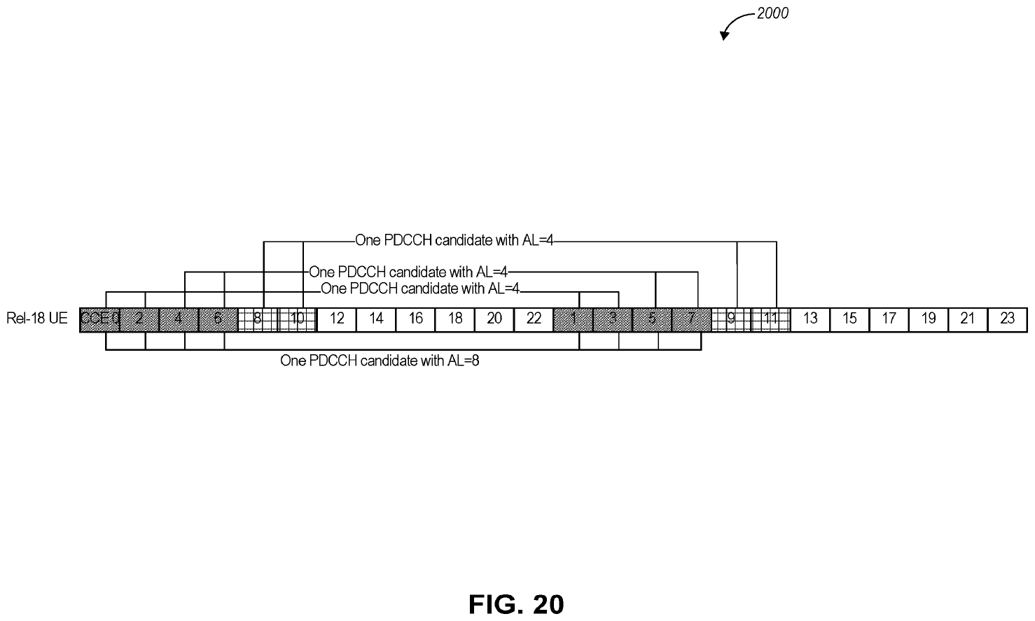

In some embodiments, the frequency region for PDCCH reception by RBW-RedCap UE is in Y PRBs starting from a reference point in the frequency domain, the PRBs can be consecutive or distributed. In this scheme, both legacy UE and RBW-RedCap UE with reduced bandwidth assumes CCE-to-REG mapping is performed within CORESET 0 bandwidth. For example, Y=24 PRBs which is 12 CCEs for a CORESET with 3 symbol duration. The UE can monitor a PDCCH candidate no larger than AL=12, e.g., AL=8. Alternatively, within a CORESET, UE can monitor one or multiple PDCCH candidates as long as the total number of PRBs is no larger than Y. For example and as shown in diagram 2000 in FIG. 20, the UE can monitor 3 PDCCH candidates with AL=4 and 1 PDCCH candidate with AL=8, which occupies 24 PRBs. A pre-defined rule is needed to determine the number of candidates and aggregation level, e.g., prioritize higher AL that does not exceed Y PRBs.

In some embodiments, a system and method to enhance control channel transmission for UE with reduced bandwidth can perform functionalities including receiving by the UE, a configuration on the control resource set (CORESET). The UE detects a Physical Downlink Control Channel (PDCCH). The UE receives the PDSCH scheduled by the PDCCH. In some aspects, a PDCCH candidate is repeatedly mapped to the same set of CCEs on two or more occasions of the same CORESET. In some aspects, a PDCCH candidate is mapped to the same set of CCEs on two or more occasions of the same CORESET with different CCE-to-REG mapping in each occasion. In some aspects, the CCE-to-REG mapping is defined within a CORESET. In some embodiments, the parameter n_{shift} is replaced by n_{shift}+Δₖ for occasion k, Δₖ≥0, k=0, 1, . . . , of the two or more occasions. In some embodiments, the non-interleaved CCE-to-REG mapping is used with an offset Δₖ for occasion k, Δₖ≥0, k=0, 1, . . . , of the two or more occasions. In some aspects, a PDCCH candidate is mapped to the CCEs on two or more occasions of the same CORESET, the REG bundles in the two or multiple occasions are consecutively numbered, and the CCE-to-REG mapping is defined across the two or multiple occasions.

In some embodiments, K PDCCH candidates respectively from the K occasions of CORESET are bundled into a bundled PDCCH candidate. In some aspects, the K PDCCH candidates that are bundled have the same AL and the same PDCCH candidate index in the SS set in the respective occasions of the CORESETs. In some embodiments, the K PDCCH candidates that are bundled have the same AL and a predefine rule is used to determine the PDCCH candidate index in respective CORESET. In some embodiments, the K PDCCH candidates that are bundled have different AL. In some embodiments, a CORESET is configured with up to N_{symb}^{CORESET} OFDM symbols, N_{symb}^{CORESET}>3

In some embodiments, the UE does PDCCH reception in a frequency region that is part of the CORESET 0. In some embodiments, the frequency region for PDCCH reception is in Y consecutive PRBs starting from a reference point. In some embodiments, CCE-to-REG mapping is performed within the frequency region. In some embodiments, CCE-to-REG mapping is performed within CORESET 0 bandwidth. In some aspects, additional N symbols are allocated for PDCCH reception. In some embodiments, the same CCE-to-REG mapping is applied for both CORESET 0 N symbols and additional N symbols respectively in the overlapping PRBs of the frequency region. In some embodiments, one REG bundle maps onto the 2N symbols. In some embodiments, the REGs are continuously indexed after the last REG index in the frequency region for PDCCH reception in CORESET #0 with an offset.

The disclosed techniques include enhancements for DL or UL transmission for UE with reduced bandwidth. In particular, the disclosed techniques include maximum transport block size (TBS) determination, maximum data rate configuration, PUSCH repetition with long retuning time for BWP switching, and early identification of F-RedCap UEs.

To reduce the complexity for a RedCap UE (F-RedCap UE), further reduction of bandwidth at least for the data channel of the base band (BB) processing can be considered. Alternatively, the complexity reduction may be facilitated by the support of reduced peak data rates. That is, any scheme that results in a reduction may be considered, which is not limited to the use of small bandwidth.

The following configurations can be used for maximum TBS determination.

In some embodiments, to reduce the cost, one solution is to limit the maximum transport block size of a PDSCH or a PUSCH that can be supported by an F-RedCap UE to TBS₁^{max} or TBS₂^{max} bits respectively. TBS₁^{max} or TBS₂^{max} are predefined or configured by higher-layer signaling. TBS₁^{max} may be predefined or configured the same as or different from TBS₂^{max}. For example, TBS₁^{max} or TBS₂^{max} may be 3824 bits. In this way, F-RedCap UE can support a single LDPC encoding scheme. Alternatively, TBS₁^{max} or TBS₂^{max} may be 2976 bits. As long as TBS₁^{max} is no smaller than 2976 bits, any limitation on the PDSCH assigned by a PDCCH with CRC scrambled by SI-RNTI can be avoided.

In some embodiments, the TBS determination as defined in TS 38.214 can be reused with a limitation on the maximum TBS. For the PDSCH assigned by a PDCCH with DCI format 1_0, format 1_1, or format 1_2 with CRC scrambled by C-RNTI, MCS-C-RNTI, TC-RNTI, CS-RNTI, or SI-RNTI, if Table 5.1.3.1-2 is used and 0≤I_{MCS}≤27, or a table other than Table 5.1.3.1-2 is used and 0≤I_{MCS}≤28, the UE shall, except if the transport block is disabled in DCI format 1_1, first determine the TBS as specified below:
(a) The UE shall first determine the number of REs (NRE) within the slot.
(a.1) A UE first determines the number of REs allocated for PDSCH where a PRB (N′_{RE}) by N′_{RE}=N_{sc}^{RB}·N_{symb}^{sh}−N_{DMRS}^{PRB}−Nₒₕ^{PRB}, where N_{sc}^{RB}=12. is the number of subcarriers in a physical resource block, N_{symb}^{sh} is the number of symbols of the PDSCH allocation within the slot, N_{DMRS}^{PRB} is the number of RES for DM-RS per PRB in the scheduled duration including the overhead of the DM-RS CDM groups without data, as indicated by DCI format 1_1 or format 1_2 or as described for format 1_0 in Clause 5.1.6.2, and Nₒₕ^{PRB} is the overhead, PRB configured by higher layer parameter xOverhead in PDSCH-ServingCellConfig. If the xOverhead in PDSCH-ServingCellconfig is not configured (a value from 6, 12, or 18), the Nₒₕ^{PRB} is set to 0. If the PDSCH is scheduled by PDCCH with a CRC scrambled by SI-RNTI, RA-RNTI, MSGB-RNTI, or P-RNTI, oh Nₒₕ^{PRB} is assumed to be 0.
(a.2) A UE determines the total number of REs allocated for PDSCH (N_{RE}) by N_{RE}=min(156, N′_{RE})·n_{PRB}, where nPRB is the total number of allocated PRBs for the UE.
(b) Unquantized intermediate variable (Ninfo) is obtained by N_{info}=min (N_{RE}·R·Qₘ·v, TBS^{max}), where TBS^{max} is TBS₁^{max} for TBS determination of PDSCH, or TBS₂^{max} if the procedure is reused for TBS determination of PUSCH. TBS is determined as follows:
(b.1) quantized intermediate number of information bits

$${N}_{inf o}^{′} = max ( 24 , {2}^{n} \cdot ⌊ \frac{{N}_{inf o}}{{2}^{n}} ⌋ ) ,$$

where n=max(3, └ log₂ (N_{info})┘−6)
(b.2) use Table 2 below (TBS for N_{info}≤3824) to find the closest TBS that is not less than N′_{info}.

TABLE 2

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

In some embodiments, in a slot with multiple semi-statically configured or dynamically scheduled PDSCHs or PUSCHs, the sum of the TBSs of the multiple PDSCHs or PUSCHs should be limited to TBS₃^{max} or TBS₄^{max} bits. TBS₃^{max} or TBS₄^{max} are predefined or configured by higher-layer signaling. TBS₃^{max} may be predefined or configured the same as or different from TBS₄^{max}. TBS₃^{max} or TBS₄^{max} may be respectively equal to TBS₁^{max} or TBS₂^{max}. TBS₃^{max} or TBS₄^{max} may be predefined values that are larger than TBS₁^{max} or TBS₂^{max} respectively. The above PDSCHs or PUSCHs may be scheduled by a DCI with any applicable RNTI. In particular, it includes both unicast PDSCH or PUSCH and broadcast PDSCH.

In some embodiments, if multiple semi-statically configured or dynamically scheduled PDSCHs or PUSCHs in the same or different slots are not correctly received/transmitted, an F-RedCap UE may expect the sum of the TBSs of the multiple PDSCHs or PUSCHs should be limited to TBS₅^{max} or TBS₆^{max} bits. For PDSCH transmission, UE may assume the PDSCH is correctly received if the TB CRC checking is correct. On the other hand, for PUSCH transmission, UE may consider a PUSCH is correctly transmitted when a toggled NDI for the same HARQ process is received in a new DCI format. TBS₅^{max} or TBS₆^{max} are predefined or configured by higher-layer signaling. TBS₅^{max} may be predefined or configured the same as or different from TBS₆^{max}. TBS₅^{max} or TBS₆^{max} may be respectively no more than H₁·TBS₁^{max} or H₂·TBS₂^{max}, where H₁, H₂ are the maximum number of HARQ processes for DL or UL transmissions.

In some embodiments, if an F-RedCap UE needs to transmit a PUCCH and a PUSCH in a slot, the total number of bits of the UCI payload and the TBS of the UL-SCH should not exceed a maximum number TBS₈^{max}, TBS₈^{max} can be predefined or configured by higher-layer signaling. TBS₈^{max} can be the same as or different from TBS₂^{max}.

In some aspects, the total number of bits of the UCI payload and the TBS of the UL-SCH can be separately predefined or configured for the following two cases. If the PUCCH and PUSCH are in the same slot and overlapped, i.e., the UE transmits the UCI on the PUSCH, the total number of bits of the UCI payload and the TBS of the UL-SCH is TBS_{8,1}^{max}. On the other hand, if the PUCCH and PUSCH are in the same slot but do not overlap, i.e., the UE transmits the UCI payload and the UL-SCH separately, the total number of bits of the UCI payload and the TBS of the UL-SCH is TBS_{8,2}^{max}. TBS_{8,1}^{max} may be predefined or configured the same as or different from TBS_{8,2}^{max}.

In some embodiments, if an F-RedCap UE needs to transmit a PUCCH and a PUSCH in a slot, the number of bits for PUSCH transmission is not impacted by the UCI transmission, i.e., it is still limited by TBS₂^{max}, or TBS₄^{max}. Further, the UCI payload on a PUCCH is no more than TBS₁₀^{max}. TBS₁₀^{max} can be predefined or configured by higher-layer signaling. For example, TBS₁₀^{max} may be equal to 1706 bits.

The following configurations can be used for the maximum data rate.

In some embodiments, to reduce the complexity, the maximum data rate can be relaxed for a UE. In Clause 4.1.2 in TS 38.306, it is specified that, for NR, the approximate data rate for a given number of aggregated carriers in a band or band combination is computed as follows. For RedCap UE, J=1. The data rate can be determined based on the following equation:

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{PRB}^{B W ( j ) , μ} \cdot 12}{{T}_{s}^{μ}} \cdot ( 1 - O {H}^{( j )} ) ) ,$$

where J is the number of aggregated component carriers in a band or band combination, and Rmax=948/1024. For the j^{th} CC, v_{Layers}^{(j)} is the maximum number of supported layers given by higher layer parameter maxNumberMIMO-LayersPDSCH for downlink and a maximum of higher layer parameters maxNumberMIMO-LayersCB-PUSCH and maxNumberMIMO-LayersNonCB-PUSCH for uplink. Qₘ^{(j)} is the maximum supported modulation order given by the higher layer parameter supportedModulationOrderDL for downlink and the higher layer parameter supportedModulationOrderUL for uplink. f^{(j)} is the scaling factor given by the higher layer parameter scalingFactor and can take the values 1, 0.8, 0.75, and 0.4. μ is the numerology (as defined in TS 38.211 [6]). Tₛ^{μ} is the average OFDM symbol duration in a subframe for numerology μ, i.e.

$${T}_{s}^{μ} = \frac{{10}^{- 3}}{14 \cdot {2}^{μ}} .$$

Note that a normal cyclic prefix is assumed. N_{PRB}^{BW(j),μ} is the maximum RB allocation in bandwidth BW^{(j)} with numerology μ, as defined in 5.3 TS 38.101-1 [2] and 5.3 TS 38.101-2 [3], where BW^{(j)} is the UE-supported maximum bandwidth in the given band or band combination. OH^{(j)} is overhead and takes the following values: 0.14, for frequency range FRI for DL, 0.18, for frequency range FR2 for DL, 0.08, for frequency range FRI for UL, and 0.10, for frequency range FR2 for UL.

In some embodiments, for an F-RedCap UE that can be configured with a DL/UL BWP of up to 20 MHz BW, the parameter N_{PRB}^{BW(j),μ} may be set to N_{RBW} PRBs, where N_{RBW} may equal 25 for SCS 15 kHz or 12 for SCS 30 kHz for 5 MHz BW of PDSCH or PUSCH transmission.

As an alternative or in addition to the above option, for an F-RedCap UE that can be configured with a DL/UL BWP of up to 20 MHz BW, the additional value of the parameter f^{(j)} may be introduced to support more values of the product v_{Layers}^{(j)}·Qₘ^{(j)}·f^{(j)}. The product v_{Layers}^{(j)}·Qₘ^{(j)}·f^{(j)} reported by UE can be smaller than 4.

Correspondingly, the sum of the TB size of the multiple PDSCHs in a slot limited by the above DataRate, a UE is not required to handle PDSCH(s) transmissions in slot sj in serving cell-j, and for j=0, 1, 2 . . . J−1, J=1 for RedCap UE, slot sj overlapping with any given point in time, if the following condition is not satisfied at that point in time as defined in TS 38.214:

$${\sum }_{j = 0}^{J - 1} \frac{{\sum }_{m = 0}^{M - 1} {V}_{j , m}}{{T}_{s l o t}^{μ ( j )}} \leq DateRate ,$$

where J is the number of configured serving cells belonging to a frequency range; and for the j^{th} serving cell, M is the number of TB(s) transmitted in slot sj. If there are two PDSCH transmission occasions of the same TB (in the time domain or frequency domain) in the slot sj, each transmission occasion is counted separately. Tslotμ(j)=10-3/2μ(j), where μ(j) is the numerology for PDSCH(s) in slot sj of the j^{th} serving cell. For the m^{th} TB,

$${V}_{j , m} = {C}^{′} \cdot ⌊ \frac{A}{C} ⌋ ,$$

where A is the number of bits in the transport block as defined in Clause 7.2.1 [5, TS 38.212], C is the total number of code blocks for the transport block defined in Clause 5.2.2 [5, TS 38.212], C′ is the number of scheduled code blocks for the transport block as defined in Clause 5.4.2.1 [5, TS 38.212], and DataRate [Mbps] is computed as the maximum data rate summed over all the carriers in the frequency range for any signaled band combination and feature set consistent with the configured servings cells, where the data rate value is given by the formula in Clause 4.1.2 in [13, TS 38.306], including the scaling factor f(i).

In some embodiments, to reduce the complexity, the maximum data rate can be relaxed for a UE by reducing TBS_{LBRM}. In TS 38.213, it is specified that the UE is not expected to handle any transport blocks (TBs) in a 14 consecutive-symbol duration for normal CP (or 12 for extended CP) ending at the last symbol of the latest PDSCH transmission within an active BWP on a serving cell whenever

$${2}^{max ( 0 , μ - {μ}^{′} )} \cdot {\sum }_{i ∈ S} ⌊ \frac{{c}_{i}^{′}}{{L}_{i}} ⌋ {x}_{i} \cdot {F}_{i} > ⌈ \frac{X}{4} ⌉ \cdot \frac{1}{{R}_{L B R M}} \cdot {TBS}_{L B R M} ,$$

where, for the serving cell: S is the set of TBs belonging to PDSCH(s) that are partially or fully contained in the consecutive-symbol duration; for the ith TB: Ci′ is the number of scheduled code blocks as defined in [5, 38.212], Li is the number of OFDM symbols assigned to the PDSCH, xi is the number of OFDM symbols of the PDSCH contained in the consecutive-symbol duration,

$${F}_{i} = {max}_{j = 0 , … , J − 1} ( min ( {k}_{0 , i}^{j} + {E}_{i}^{j} , {N}_{c b , i} ) )$$

based on the values defined in Clause 5.4.2.1 [5, TS 38.212], k_{0,i}^{j} is the starting location of RV for the jth transmission, Eᵢ^{j}=min(Eᵣ) of the scheduled code blocks for the jth transmission, N_{cb,i} is the circular buffer length, J−1 is the current (re) transmission for the ith TB, μ′ corresponds to the subcarrier spacing of the BWP (across all configured BWPs of a carrier) that has the largest configured number of PRBs. In case more than one BWP is corresponding to the largest configured number of PRBs, μ′ follows the BWP with the largest subcarrier spacing, where μ corresponds to the subcarrier spacing of the active BWP, R_{LBRM}=2/3 as defined in Clause 5.4.2.1 [5, TS 38.212], TBS_{LBRM} as defined in Clause 5.4.2.1 [5, TS 38.212], and X as defined for downlink in Clause 5.4.2.1 [5, TS 38.212].

In TS 38.212, it is specified that, for the r-th code block, let N_{cb}=N if I_{LBRM}=0 and N_{cb}=min(N, N_{ref}) otherwise, where

$${N}_{ref} ⌊ \frac{T B {S}_{LBRM}}{C \cdot {R}_{LBRM}} ⌋ , {R}_{LBRM} = 2 / 3 ,$$

TBS_{LBRM} is determined according to Clause 6.1.4.2 in [6, TS 38.214] for UL-SCH and Clause 5.1.3.2 in [6, TS 38.214] for DL-SCH/PCH, assuming the following:
(a) maximum number of layers for one TB for UL-SCH is given by X, where
(a.1) if the higher layer parameter maxMIMO-Layers of PUSCH-ServingCellConfig of the serving cell is configured, X is given by that parameter
(a.2) else if the higher layer parameter maxRank of pusch-Config of the serving cell is configured, X is given by the maximum value of maxRank across all BWPs of the serving cell
(a.3) otherwise, X is given by the maximum number of layers for PUSCH supported by the UE for the serving cell.
(b) maximum number of layers for one TB for DL-SCH/PCH is given by the minimum of X and 4, where
(b.1) if the higher layer parameter maxMIMO-Layers of PDSCH-ServingCellConfig of the serving cell is configured, X is given by that parameter
(b.2) otherwise, X is given by the maximum number of layers for PDSCH supported by the UE for the serving cell.
(c) if the higher layer parameter mcs-Table or mcs-TableDCI-1-2 given by a pdsch-Config for at least one DL BWP of the serving cell is set to ‘qam256’, maximum modulation order Qₘ=8 is assumed for DL-SCH; otherwise a maximum modulation order Qₘ=6 is assumed for DL-SCH;
(d) if the higher layer parameter mcs-Table or mcs-TableTransformPrecoder or mcs-TableDCI-0-2 or mcs-TableTransformPrecoderDCI-0-2 given by a pusch-Config or the higher layer parameter mcs-Table or mcs-TableTransformPrecoder given by configuredGrantConfig for at least one UL BWP of the serving cell is set to ‘qam256’, maximum modulation order Qₘ=8 is assumed for UL-SCH; otherwise, a maximum modulation order Qₘ=6 is assumed for UL-SCH
(e) maximum coding rate of 948/1024;
(f) n_{PRB}=n_{PRB,LBRM} is given by Table 3 (value of n_{PRB,LBRM}),
   where the value of n_{PRB,LBRM} for DL-SCH is determined according to the initial downlink bandwidth part if there is no other downlink bandwidth part configured to the UE;

$$( g ) {N}_{R E} = 156 \cdot {n}_{P R B} ;$$

(h) C is the number of code blocks of the transport block determined according to Clause 5.2.2.

TABLE 3

| Maximum number of PRBs across all | |
|---|---|
| configured DL BWPs and UL BWPs of | |
| a carrier for DL-SCH and UL-SCH, respectively | n_{PRB, LBRM} |
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

In some aspects, for an F-RedCap UE that can be configured with a DL/UL BWP of up to 20 MHz BW, the parameter n_{PRB} to calculate TBS_{LBRM} can be set to N_{RBW} PRBs, where N_{RBW} may equal 25 for 5 MHz BW for at least PDSCH or PUSCH transmission.

In some embodiments, for an F-RedCap UE that can be configured with a DL/UL BWP of up to 20 MHz BW, the parameter Qₘ to calculate TBS_{LBRM} can be set to Qₘ=4.

In some embodiments, for an F-RedCap UE that can be configured with a DL/UL BWP of up to 20 MHz BW, the maximum coding rate to calculate TBS_{LBRM} can be set to a value that is smaller than 948/1024.

In some aspects, for an F-RedCap UE that can be configured with a DL/UL BWP of up to 20 MHz BW, the parameter N_{RE} to calculate TBS_{LBRM} can be set to a value that is smaller than 156·n_{PRB}.

In some embodiments, if an F-RedCap UE needs to transmit a PUCCH and a PUSCH in a slot, the UE doesn't expect the total number of bits of the UCI payload and the TBS of the UL-SCH to result in exceeding a maximum data rate.

For example, within a cell group, a UE is not required to handle PUSCH(s) transmissions in slot sj in serving cell-j, and for j=0, 1, 2 . . . J−1, slot sj overlapping with any given point in time, if the following condition is not satisfied at that point in time:

$${\sum }_{j = 0}^{J - 1} \frac{{\sum }_{m = 0}^{M - 1} {V}_{j , m}}{{T}_{slot}^{μ ( j )}} \leq DataRate ,$$

where J is the number of configured serving cells belonging to a frequency range. J=1 for RedCap UE. For the j^{th} serving cell, M is the number of TB(s) transmitted in a slot sj. For PUSCH repetition Type B, each actual repetition is counted separately. For PUCCH or UCI piggybacked on PUSCH, the UCI payload is treated as a TB:
(a) Tslotμ(j)=10-3/2μ(j), where μ(j) is the numerology for PUSCH(s) in slot sj of the j-th serving cell.
(b) for the m^{th} TB,

$${V}_{j , m} = {C}^{′} \cdot ⌊ \frac{A}{C} ⌋ .$$

(b.1) A is the number of bits in the transport block as defined in Clause 6.2.1 [5, TS 38.212];
(b.2) C is the total number of code blocks for the transport block defined in Clause 5.2.2 [5, TS 38.212];
(b.3) C′ is the number of scheduled code blocks for the transport block as defined in Clause 5.4.2.1 [5,38.212].

DataRate [Mbps] is computed as the maximum data rate summed over all the carriers in the frequency range for any signaled band combination and feature set consistent with the configured servings cells, where the data rate value is given by the formula in Clause 4.1.2 in [13, TS 38.306], including the scaling factor f (i).

The following configuration can be used for PUSCH repetition with a long retuning time for BWP switching.

For Option A and B in FIG. 7, the BWP for the UE is confined within 5 MHz, i.e., up to NBW consecutive PRBs which is not good from a frequency diversity point of view. To recover the benefit of diversity, inter-BWP frequency hopping (FH) can be supported. However, a long retuning time may be necessary to support inter-BWP FH.

In Rel-17, for PUSCH repetition type A and PUSCH transmission with transport block over multiple slots (TBoMS), counting based on available slots is supported. In particular, a two-step approach is employed, where in the first step, a UE determine available slots for K repetitions based on radio resource control (RRC) configuration(s) in addition to time domain resource allocation (TDRA) in the downlink control information (DCI) scheduling the PUSCH, configured grant (CG) configuration or activation DCI. In the second step, the UE determines whether to drop a PUSCH repetition or not according to Rel-15/16 PUSCH dropping rules, but the PUSCH repetition is still counted in the K repetitions.

In the first step, in the unpaired spectrum, the UE determines a slot as an available slot when PUSCH repetition does not overlap with semi-statically configured DL symbols and flexible symbols used for synchronization signal block (SSB) transmission. In the first step, in paired spectrum with half-duplex FDD (HD-FDD) operation, the UE determines a slot as an available slot when PUSCH repetition does not overlap with symbols used for synchronization signal block (SSB) transmission. A similar mechanism is also applied for physical uplink control channel (PUCCH) repetitions in TDD systems or unpaired spectrums.

In some aspects, for the following embodiments, multi-slot PUSCH transmission includes PUSCH repetition type A, TB processing over multiple-slot PUSCH (TBoMS), and Msg3 repetition for initial transmission and retransmission.

In some embodiments, for unpaired spectrum or paired spectrum with HD-FDD operation, for the determination of available slots for multi-slot PUSCH transmission or PUCCH repetitions, a slot is not counted as an available slot:
(a) if at least one of the symbols indicated for a PUSCH or a PUCCH transmission of the multi-slot PUSCH transmission or PUCCH repetitions (respectively) overlaps with a DL symbol indicated by tdd-UL-DLConfigurationCommon or tdd-UL-DL-ConfigurationDedicated if provided, or a symbol of an SS/PBCH block, or
(b) if the gap between the last symbol of a PUSCH or a PUCCH transmission of the multi-slot PUSCH transmission or PUCCH repetitions (respectively) in the previous slot and the first symbol of a PUSCH or a PUCCH transmission of the multi-slot PUSCH transmission or PUCCH repetitions (respectively) in the current slot is less than a threshold if inter-BWP FH happens between the two slots.

The above condition (b) may be generalized as follows: if the gap between the last symbol of a UL transmission in the previous slot and the first symbol of a PUSCH or a PUCCH transmission of the multi-slot PUSCH transmission or PUCCH repetitions (respectively) is less than a threshold if inter-BWP FH happens between the two slots.

In some embodiments, the threshold may be the switching time for the inter-BWP FH. The threshold may be defined as the number of symbols or slots or as an absolute time in a unit of a millisecond (ms) or microsecond (μs). The threshold can be defined based on UE capability.

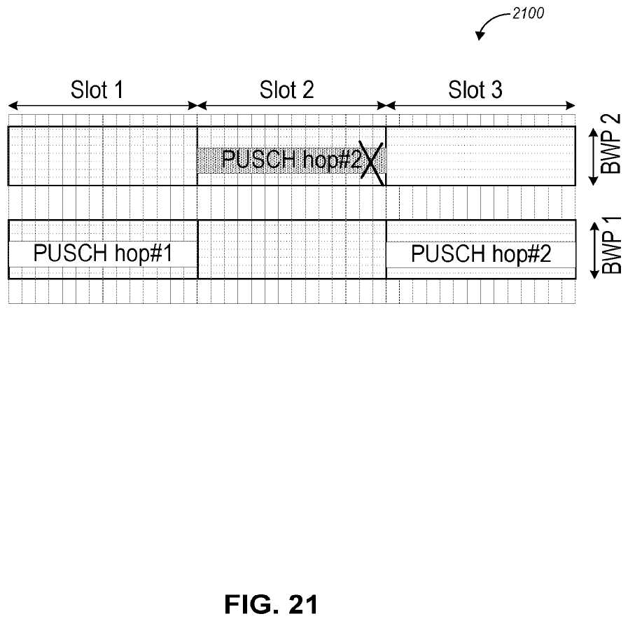

FIG. 21 illustrates diagram 2100 of one example of available slot determination for PUSCH repetition type A. In the example, 2 repetitions are allocated for PUSCH transmissions with counting based on available slots. Since there is not enough switching time for inter-BWP FH between hop #1 and hop #2 in slot 2, PUSCH hop #2 in slot 2 is not available. Therefore, the second hop of the PUSCH repetition is mapped to slot 3.

In some embodiments, inter-BWP frequency hopping can be employed in conjunction with DMRS bundling. In particular, the same frequency resource can be allocated for N slots for the multi-slot PUSCH transmission and PUCCH repetitions, where N can be configured by higher layers via dedicated RRC signaling.

Similar to inter-slot frequency hopping with inter-slot bundling, the frequency hopping pattern can be determined in accordance with the physical slot index for multi-slot PUSCH transmission, and with the relative physical slot index for PUCCH repetitions. Further, in a case when the hopping interval is not configured, the default hopping interval is the same as the configured time domain window length for DMRS bundling.

In some aspects, in a case when inter-BWP frequency hopping with inter-slot bundling is applied for multi-slot PUSCH transmission and PUCCH repetitions with counting based on available slots, the gap between the last symbol of a UL transmission in the previous slot and the first symbol of a PUSCH or a PUCCH transmission is less than a threshold if inter-BWP FH happens between the two slots, the slot is not counted as an available slot.

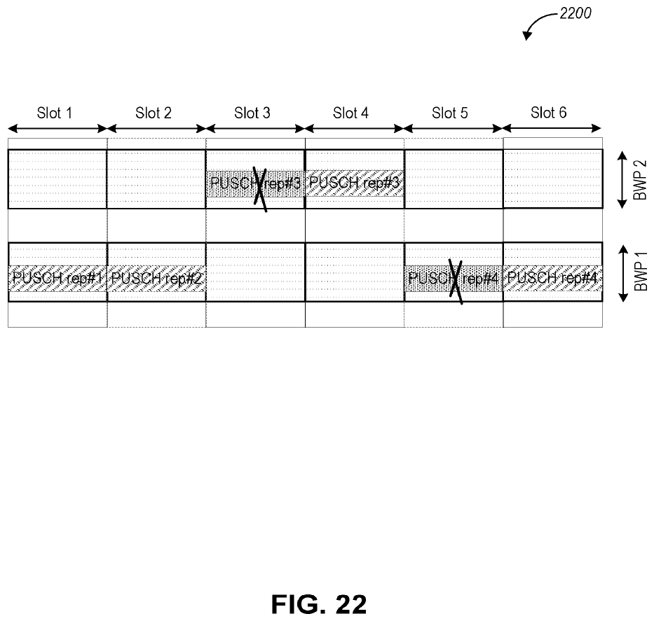

FIG. 22 illustrates diagram 2200 of another example of available slot determination when DMRS bundling for PUSCH repetition type A is configured. In the example, 4 repetitions are allocated and DMRS bundling is applied in 2 consecutive repetitions. Since there is not enough switching time for inter-BWP FH between the PUSCH repetitions in slots 2 and 3, PUSCH repetition #3 is delayed into slot 4. Further, since there is not enough switching time between slots 4 and 5, PUSCH repetition #4 is delayed into slot 6.

In case when inter-BWP frequency hopping with inter-slot bundling is applied for multi-slot PUSCH transmission and PUCCH repetitions with counting based on physical slots, the gap between the last symbol of a UL transmission in the previous slot and the first symbol of a PUSCH or a PUCCH transmission is less than a threshold if inter-BWP FH happens between the two slots, the PUSCH or PUCCH transmission in slot may be dropped.

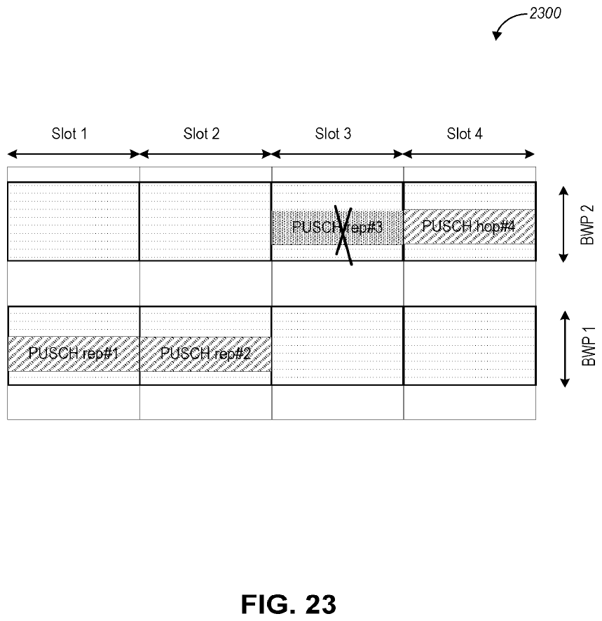

FIG. 23 illustrates diagram 2300 of another example of cancellation of a PUSCH repetition when DMRS bundling for PUSCH repetition type A is configured. In the example, 4 repetitions are allocated and DMRS bundling is applied in 2 consecutive repetitions. Since there is not enough switching time for inter-BWP FH between the PUSCH repetitions in slots 2 and 3, PUSCH repetition #3 is canceled. Due to the cancellation of PUSCH repetition #3, there is enough switching time for inter-BWP FH between repetition #4 and a previous repetition #2, therefore, repetition #4 can be transmitted.

In another option, for inter-BWP frequency hopping with inter-slot bunding, the UE performs the frequency hopping in a slot where the gap between the last symbol of a UL transmission in the previous slot and the first symbol of a PUSCH or a PUCCH transmission in the slot is greater than or equal to a threshold.

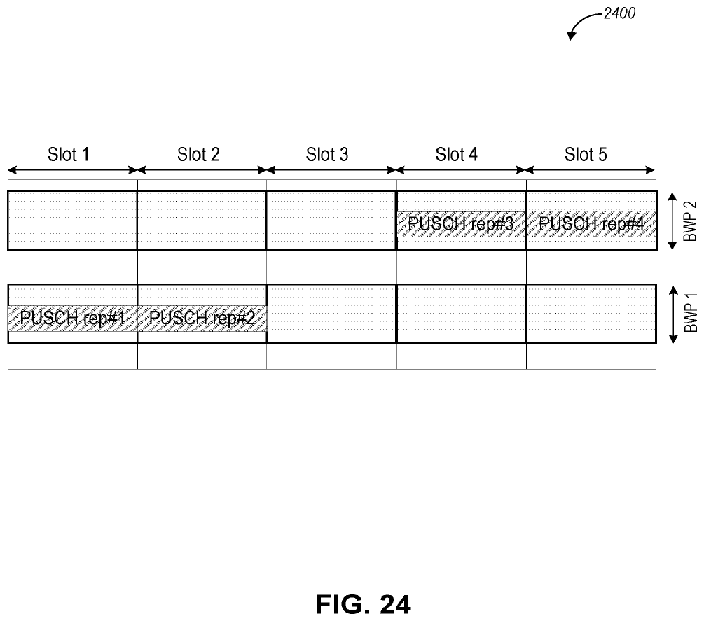

FIG. 24 illustrates diagram 2400 of another example of inter-BWP frequency hopping with DMRS bundling. In the example, 4 repetitions are allocated and DMRS bundling is applied in 2 consecutive repetitions. Since there is not enough switching time for inter-BWP FH between the PUSCH repetitions in slots 2 and 3, PUSCH repetition #3 is delayed into slot 4. Further, PUSCH repetition #4 is delayed into slot 5.

In one embodiment of the invention, for inter-BWP frequency hopping with inter-slot bundling, denote the frequency hopping interval as H slots, and the PUSCH transmission with N·K repetitions switches to a different BWP in every H slot. A gap of x slots can be configured for BWP switching. The x slots are not counted in the N·K repetitions. The value x can be predefined, reported by UE capability, or configured by higher layer signaling. For example, x=1 slot if the gap between the last symbol of a UL transmission in the previous slot and the first symbol of a PUSCH or a PUCCH transmission in the slot is greater than or equal to a threshold.

In one option, when the UE hops from a current BWP to the next BWP, a number of x slots are configured as a gap at the end of the current BWP.

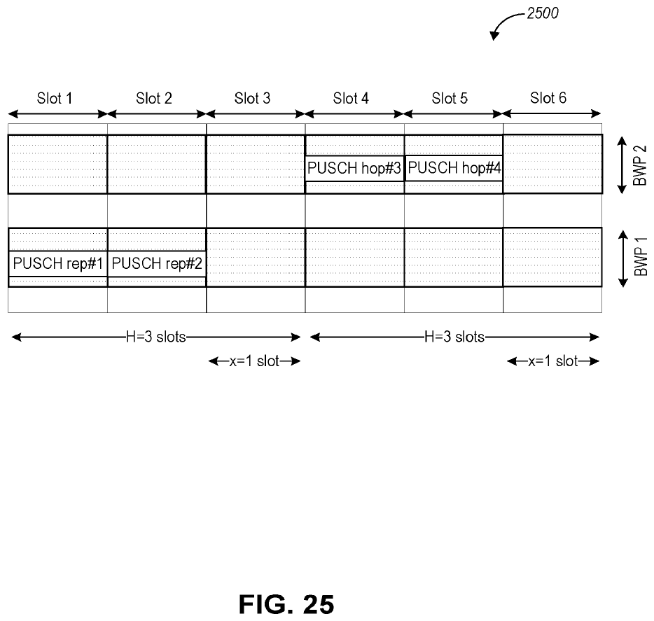

FIG. 25 illustrates diagram 2500 of another example of inter-BWP frequency hopping with DMRS bundling. In the example, inter-BWP FH applies in every H=3 slot with gap x=1 slot. 2 repetitions are allocated in slots 1 and 2, while another 2 repetitions are allocated in slots 4 and 5. The DMRS bundling is applied in 2 consecutive repetitions.

In some aspects, when the UE hops from a current BWP to the next BWP, a number of x slots are configured as a gap at the beginning of the next BWP.

In some aspects, when the UE hops from a current BWP to the next BWP, a number of x slots are configured as a gap in both the end of the current BWP and the beginning of the next BWP. For example, └x/2┘ or ┌x/2┐ are allocated at the end of the current BWP.

If counting based on available slots is configured to determine the available slots for PUSCH or PUCCH transmission, the UE considers the above x slots are not available for transmission. If counting based on physical slots is configured to determine the physical slots for PUSCH or PUCCH transmission, the UE skip the above x slots without counting them in the N·K repetitions.

In some embodiments, for unpaired spectrum or paired spectrum with HD-FDD operation, a current slot for multi-slot PUSCH transmission is canceled:
(a) if at least one of the symbols indicated for a PUSCH transmission of the multi-slot PUSCH transmission overlaps with a DL symbol indicated by tdd-UL-DLConfigurationCommon or tdd-UL-DL-ConfigurationDedicated if provided, or a symbol of an SS/PBCH block, or
(b) if the gap between the last symbol of a PUSCH transmission of the multi-slot PUSCH transmission in the previous slot and the first symbol of a PUSCH transmission of the multi-slot PUSCH transmission in the current slot is less than a threshold if inter-BWP FH happens between the two slots.

In some embodiments, the above condition (b) may be generalized as follows: if the gap between the last symbol of a UL transmission in the previous slot and the first symbol of a PUSCH transmission of the multi-slot PUSCH is less than a threshold if inter-BWP FH happens between the two slots.

In some aspects, the threshold may be the switching time for the inter-BWP FH. The threshold may be defined as a number of symbols or slots or as an absolute time in a unit of a millisecond (ms) or microsecond (us). The threshold can be defined based on UE capability.

In some aspects, this option may apply for multi-slot PUSCH transmission and PUCCH repetitions with counting based on physical slots.

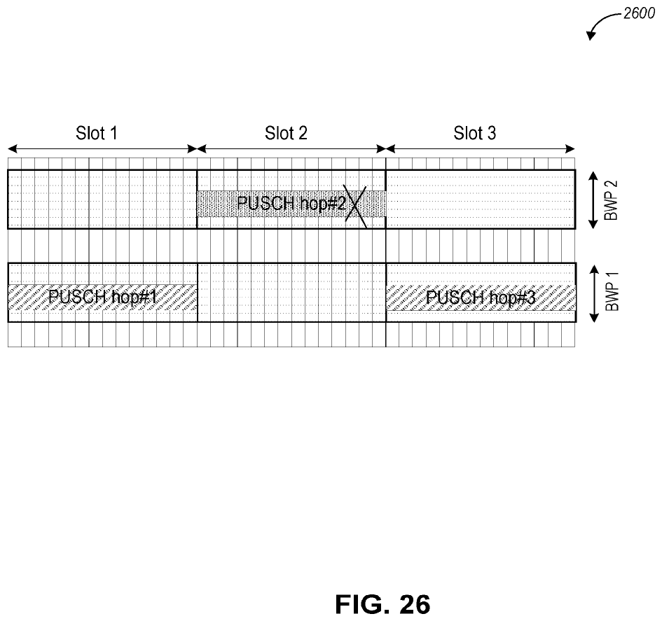

FIG. 26 illustrates diagram 2600 of one example of cancellation of a PUSCH repetition. In the example, 3 repetitions are allocated for PUSCH transmissions. Since there is not enough switching time for inter-BWP FH between hop #2 and a previous hop #1, PUSCH hop #2 is canceled. Due to the cancellation of hop #2, there is enough switching time for inter-BWP FH between hop #3 and a previous hop #1, therefore, hop #3 can be transmitted.

The following configurations can be used for the early identification of F-RedCap UEs.

In some embodiments, the F-RedCap UE has reduced capability on the bandwidth of the applicable DL or UL transmission or limited maximum TBS. Without knowledge of the UE type, the gNB has to configure or schedule a DL or UL channel/signal assuming an F-RedCap UE if blind detection is to be avoided. As a result, it hurts the performance of a non-F-RedCap UE, e.g., the longer delay during random access. Based on the analysis, it is beneficial to support the early identification of F-RedCap UE. After the identification of an F-RedCap UE, the later message can be scheduled based on the identified UE type.

In some embodiments, a separate initial UL BWP may be configured via SIB signaling for an F-RedCap UE which is a different BWP from other UEs. The separate initial UL BWP may be up to 5 MHz considering Option A or B in FIG. 1, or up to 20 MHz considering Option C in FIG. 1. The separate initial UL BWP is different from the initial UL BWP for the RedCap UEs and non-RedCap UEs. It is not restricted if the RedCap UEs and non-RedCap UEs are configured in the same initial UL BWP or not. After detection of a PRACH preamble in the RACH occasions (ROs) configured in the separate initial UL BWP, gNB knows it is from an F-RedCap UE. Correspondingly, the associated msg3 and/or PUCCH for msg4 need to be scheduled with reduced capability in the separate initial UL BWP, and the associated RAR and msg4 may be scheduled with reduced capability in the frequency region of CORESET 0 or a separate initial DL BWP. The latter may be used in deployments with unpaired spectrum to ensure center frequency alignment between separate initial UL BWP for F-RedCap UE and the initial DL BWP in which PDCCH and PDSCH are associated with a random access procedure. For Type-2 random access, after detection of a PRACH preamble and/or the associated msgA PUSCH in the separate initial UL BWP, the gNB is aware it is from an F-RedCap UE. Only the associated msgB and/or PUCCH for msgB need to be scheduled with reduced capability, e.g., no more than 25 PRBs for 15 kHz SCS.

In some embodiments, when a separate initial UL BWP for F-RedCap UEs is not configured, an F-RedCap UE may transmit PRACH or MsgA (latter for 2-step RACH) in an initial UL BWP that is configured for RedCap UEs if provided, or in an initial UL BWP that may be configured for non-RedCap UEs. In the former case, the non-RedCap UEs use a different initial UL BWP. In the latter case, all UEs use the same initial UL BWP. The shared initial UL BWP may be up to 5 MHz considering Option A or B in FIG. 1, or up to 20 MHz considering Option C in FIG. 7.

In some embodiments, the separate ROs for F-RedCap UE can be configured in the initial UL BWP. In case all UE shares the same initial UL BWP, it is not restricted if the RedCap UEs are configured with separate ROs from non-RedCap UEs or not. After the detection of a PRACH preamble in the separate ROs, gNB knows it is from an F-RedCap UE. For Type-2 random access, after detection of a PRACH preamble in the separate ROs and/or the associated msgA PUSCH, gNB knows it is from an F-RedCap UE.

In some embodiments, the separate PRACH preambles can be configured in the ROs that are shared by F-RedCap UEs and other UEs. In case all UE shares the same initial UL BWP, it is not restricted if the RedCap UEs are configured with separate PRACH preambles from non-RedCap UEs or not. After detection of a PRACH preamble belonging to the set of separate PRACH preambles, gNB knows it is from an F-RedCap UE. For Type-2 random access, after detection of a PRACH preamble belonging to the set of separate PRACH preambles and/or the associated msgA PUSCH, gNB knows it is from an F-RedCap UE.

In some embodiments, after identification of an F-RedCap UE, only the associated msg3 and/or PUCCH for msg4 need to be scheduled with reduced capability in the initial UL BWP, and only the associated RAR and msg4 can be scheduled with reduced capability in the frequency region of CORESET 0 or a separate initial DL BWP. For example, the number of allocated PRBs can be limited to no more than 25 PRBs. For Type-2 random access, only the associated msgB and/or PUCCH for msgB need to be scheduled with reduced capability, e.g., no more than 25 PRBs.

In some embodiments, the msg3 may include a dedicated LCID for F-RedCap UE identification. With this solution, gNB may still need to schedule RAR and msg3 assuming an F-RedCap UE if blind detection is to be avoided. On the other hand, after the identification of the UE type by msg3, the later message can be scheduled based on the identified UE type. For an F-RedCap UE, only the associated msg4 and/or PUCCH for msg4 need to be scheduled with reduced capability, e.g., no more than 25 PRBs.

A system and method for DL or UL transmission for UE with reduced bandwidth include one or more of the following functionalities: receiving by a UE, the configuration on the DL or UL transmission; detecting by a UE, a Physical Downlink Control Channel (PDCCH); and transmitting by the UE, a UL channel/signals according to the configuration or scheduled by the PDCCH. In some aspects, one or more of the following parameters does not exceed the corresponding maximum values: the maximum transport block size of a PDSCH or a PUSCH, the sum of the TBSs of the multiple PDSCHs or PUSCHs in a slot, the sum of the TBSs of the multiple PDSCHs or PUSCHs that are not correctly received or transmitted, and the total number of bits of the UCI payload and the TBS of the UL-SCH.

In some aspects, for a DL/UL BWP of up to 20 MHz, to calculate a maximum data rate, the parameter N_{PRB}^{BW(j),μ} is set to N_{RBW} PRBs, where N_{RBW}=25.

In some aspects, the additional value of the parameter f^{(j)} is introduced. In some aspects, for a DL/UL BWP of up to 20 MHz, to calculate the transport block size TBS_{LBRM}, one or more of the following parameters are adopted: the parameter n_{PRB} is set to N_{RBW} PRBs, where N_{RBW}=25; the parameter Qₘ to calculate TBS_{LBRM} is set to Qₘ=4; the maximum coding rate to calculate TBS_{LBRM} is smaller than 948/1024; and the parameter N_{RE} to calculate TBS_{LBRM} is smaller than 156·n_{PRB}.

In some aspects, for the determination of available slots for multi-slot PUSCH transmission or PUCCH repetitions, a slot is not counted as an available slot: (a) if at least one of the symbols indicated for a PUSCH or a PUCCH transmission of the multi-slot PUSCH transmission or PUCCH repetitions (respectively) overlaps with a DL symbol indicated by tdd-UL-DLConfigurationCommon or tdd-UL-DL-ConfigurationDedicated if provided, or a symbol of an SS/PBCH block, or (b) if the gap between last symbol of a PUSCH or a PUCCH transmission of the multi-slot PUSCH transmission or PUCCH repetitions (respectively) in the previous slot and the first symbol of a PUSCH or a PUCCH transmission of the multi-slot PUSCH transmission or PUCCH repetitions (respectively) in the current slot is less than a threshold if inter-BWP FH happens between the two slots.

In some aspects, inter-BWP frequency hopping is employed in conjunction with DMRS bundling, same frequency resource is allocated for N slots for the multi-slot PUSCH transmission and PUCCH repetitions, where Nis configured by higher layers via dedicated RRC signaling. In some aspects, the frequency hopping pattern is determined in accordance with the physical slot index for multi-slot PUSCH transmission, and with the relative physical slot index for PUCCH repetitions.

In some aspects, a slot for multi-slot PUSCH transmission is canceled: (a) if at least one of the symbols indicated for a PUSCH transmission of the multi-slot PUSCH transmission overlaps with a DL symbol indicated by tdd-UL-DLConfigurationCommon or tdd-UL-DL-ConfigurationDedicated if provided, or a symbol of an SS/PBCH block, or (b) if the gap between last symbol of a PUSCH transmission of the multi-slot PUSCH transmission in the previous slot and the first symbol of a PUSCH transmission of the multi-slot PUSCH transmission in the current slot is less than a threshold if inter-BWP FH happens between the two slots.

In some aspects, a separate initial UL BWP is configured via SIB signaling for an F-RedCap UE which is a different BWP from other UEs. In some embodiments, the separate ROs for F-RedCap UE is configured in an initial UL BWP. In some aspects, the separate PRACH preambles are configured in the ROs that are shared by F-RedCap UEs and other UEs. In some embodiments, the msg3 includes a dedicated LCID for F-RedCap UE identification.

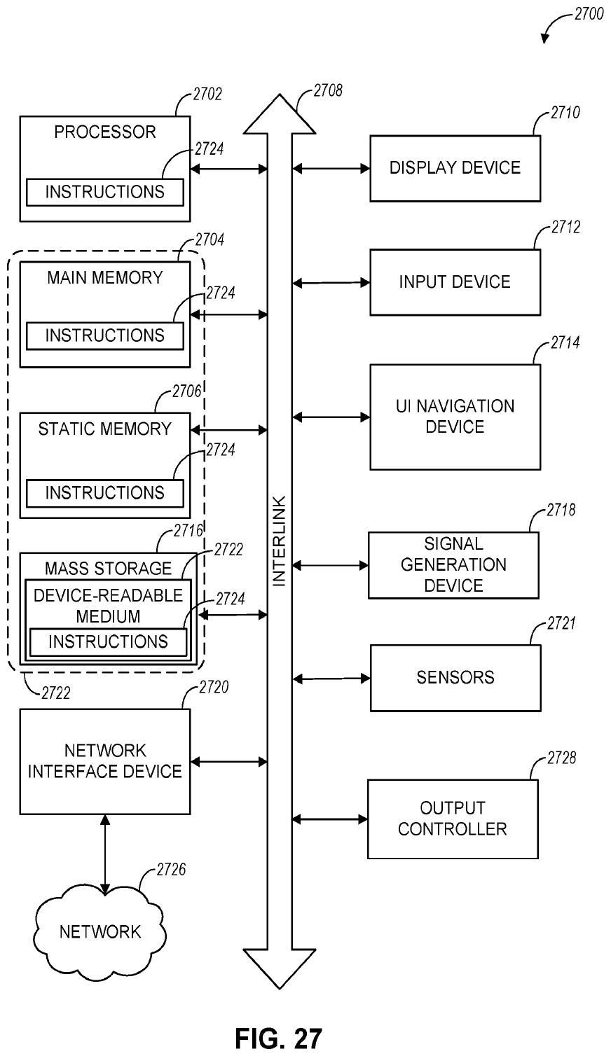

FIG. 27 illustrates a block diagram of a communication device such as an evolved Node-B (eNB), a new generation Node-B (gNB) (or another RAN node), an access point (AP), a wireless station (STA), a mobile station (MS), or user equipment (UE), in accordance with some aspects and to perform one or more of the techniques disclosed herein. In alternative aspects, the communication device 2700 may operate as a standalone device or may be connected (e.g., networked) to other communication devices.

Circuitry (e.g., processing circuitry) is a collection of circuits implemented in tangible entities of the device 2700 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in the first circuit of a first circuitry at one point in time and reused by a second circuit in the first circuitry, or by a third circuit in a second circuitry at a different time. Additional examples of these components with respect to the device 2700 follow.

In some aspects, the device 2700 may operate as a standalone device or may be connected (e.g., networked) to other devices. In a networked deployment, the communication device 2700 may operate in the capacity of a server communication device, a client communication device, or both in server-client network environments. In an example, the communication device 2700 may act as a peer communication device in a peer-to-peer (P2P) (or other distributed) network environment. The communication device 2700 may be a UE, eNB, PC, a tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules needs not to be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 2700 may include a hardware processor 2702 (e.g., a central processing unit (CPU), a graphics processing unit (GPU), a hardware processor core, or any combination thereof), a main memory 2704, a static memory 2706, and a storage device 2707 (e.g., hard drive, tape drive, flash storage, or other block or storage devices), some or all of which may communicate with each other via an interlink (e.g., bus) 2708.

The communication device 2700 may further include a display device 2710, an alphanumeric input device 2712 (e.g., a keyboard), and a user interface (UI) navigation device 2714 (e.g., a mouse). In an example, the display device 2710, input device 2712, and UI navigation device 2714 may be a touchscreen display. The communication device 2700 may additionally include a signal generation device 2718 (e.g., a speaker), a network interface device 2720, and one or more sensors 2721, such as a global positioning system (GPS) sensor, compass, accelerometer, or another sensor. The communication device 2700 may include an output controller 2728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 2707 may include a communication device-readable medium 2722, on which is stored one or more sets of data structures or instructions 2724 (e.g., software) embodying or utilized by any one or more of the techniques or functions described herein. In some aspects, registers of the processor 2702, the main memory 2704, the static memory 2706, and/or the storage device 2707 may be, or include (completely or at least partially), the device-readable medium 2722, on which is stored the one or more sets of data structures or instructions 2724, embodying or utilized by any one or more of the techniques or functions described herein. In an example, one or any combination of the hardware processor 2702, the main memory 2704, the static memory 2706, or the mass storage 2716 may constitute the device-readable medium 2722.

As used herein, the term “device-readable medium” is interchangeable with “computer-readable medium” or “machine-readable medium”. While the communication device-readable medium 2722 is illustrated as a single medium, the term “communication device-readable medium” may include a single medium or multiple media (e.g., a centralized or distributed database, and/or associated caches and servers) configured to store the one or more instructions 2724. The term “communication device-readable medium” is inclusive of the terms “machine-readable medium” or “computer-readable medium”, and may include any medium that is capable of storing, encoding, or carrying instructions (e.g., instructions 2724) for execution by the communication device 2700 and that causes the communication device 2700 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 2724 may further be transmitted or received over a communications network 2726 using a transmission medium via the network interface device 2720 utilizing any one of several transfer protocols. In an example, the network interface device 2720 may include one or more physical jacks (e.g., Ethernet, coaxial, or phone jacks) or one or more antennas to connect to the communications network 2726. In an example, the network interface device 2720 may include a plurality of antennas to wirelessly communicate using at least one of the single-input-multiple-output (SIMO), MIMO, or multiple-input-single-output (MISO) techniques. In some examples, the network interface device 2720 may wirelessly communicate using Multiple User MIMO techniques.

The term “transmission medium” shall be taken to include any intangible medium that is capable of storing, encoding, or carrying instructions for execution by the communication device 2700, and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Described implementations of the subject matter can include one or more features, alone or in combination as illustrated below by way of examples.
Example 1 is an apparatus for user equipment (UE) configured for operation in a Fifth Generation New Radio (5G NR) network, the apparatus comprising: processing circuitry, wherein to configure the UE as a Further Reduced Capacity (F-RedCap) UE in the 5G NR network, the processing circuitry is to: decode a physical broadcast channel (PBCH) to obtain a numerology parameter associated with the F-RedCap UE; determine a maximum resource block (RB) allocation for a bandwidth associated with the numerology parameter; adjust the maximum RB allocation based on a reduced bandwidth associated with the F-RedCap UE to obtain an adjusted RB allocation; determine a maximum data rate based on the numerology parameter and the adjusted RB allocation; and encode data for an uplink (UL) transmission to a base station, the UL transmission using the maximum data rate, and a memory coupled to the processing circuitry and configured to store the numerology parameter.
In Example 2, the subject matter of Example 1 includes, the reduced bandwidth is below 20 MHz and the adjusted RB allocation is 25 RBs for a sub-carrier spacing (SCS) of 15 kHz.
In Example 3, the subject matter of Examples 1-2 includes, the reduced bandwidth is below 20 MHz and the adjusted RB allocation is 12 RBs for a sub-carrier spacing (SCS) of 30 kHz.
In Example 4, the subject matter of Examples 1-3 includes subject matter where the processing circuitry is to: decode system information block (SIB) signaling received from the base station, the SIB signaling to configure a first initial UL bandwidth part (BWP) for the F-RedCap UE and a second initial UL BWP for a RedCap UE or a non-RedCap UE.
In Example 5, the subject matter of Example 4 includes subject matter where the processing circuitry is to: encode a physical random access channel (PRACH) preamble for transmission as a message-1 (msg1) in a RACH occasion (RO) configured in the first initial UL BWP.
In Example 6, the subject matter of Example 5 includes subject matter where the processing circuitry is to: decode a random access response (RAR) message from the base station, the RAR message including a scheduling grant in the first initial UL BWP.
In Example 7, the subject matter of Example 6 includes subject matter where the processing circuitry is to: encode a physical uplink shared channel (PUSCH) for a message-3 (msg3) transmission to the base station, wherein the msg3 transmission is within the first initial UL BWP and is based on the scheduling grant.
In Example 8, the subject matter of Examples 6-7 includes, the scheduling grant indicating a RO allocation of at most 25 RBs for a sub-carrier spacing (SCS) of 15 kHz.
In Example 9, the subject matter of Examples 7-8 includes subject matter where the SIB signaling further includes an initial downlink (DL)

BWP associated with the F-RedCap UE, and the processing circuitry is to: decode contention resolution information received in a message-4 (msg4) transmission from the base station, the msg4 transmission based on a second scheduling grant and using RBs within the initial DL BWP.
In Example 10, the subject matter of Examples 1-9 includes, transceiver circuitry coupled to the processing circuitry; and one or more antennas coupled to the transceiver circuitry.
Example 11 is a computer-readable storage medium that stores instructions for execution by one or more processors of a base station, the instructions to configure the base station for communication with a Further Reduced Capacity (F-RedCap) UE in a Fifth Generation New Radio (5G NR) network, and to cause the base station to perform operations comprising: encoding a physical broadcast channel (PBCH) for transmission to the F-RedCap UE, the PBCH including a numerology parameter associated with the F-RedCap UE; and decoding data received in an uplink (UL) transmission from the F-RedCap UE, the UL transmission using a maximum data rate, the maximum data rate based on the numerology parameter and an RB allocation, and the RB allocation being adjusted based on a reduced bandwidth associated with the F-RedCap UE.
In Example 12, the subject matter of Example 11 includes, the operations further comprising: encoding system information block (SIB) signaling for transmission to the F-RedCap UE, the SIB signaling configuring a first initial UL bandwidth part (BWP) for the F-RedCap UE, and a second initial UL BWP for a RedCap UE or a non-RedCap UE; decoding a physical random access channel (PRACH) preamble received during a message-1 (msg1) transmission in a RACH occasion (RO) configured in the first initial UL BWP; encoding a random access response (RAR) message for transmission to the F-RedCap UE, the RAR message including a scheduling grant in the first initial UL BWP; and decoding a physical uplink shared channel (PUSCH) during a message-3 (msg3) transmission, the msg3 transmission received within the first initial UL BWP and based on the scheduling grant.
Example 13 is a computer-readable storage medium that stores instructions for execution by one or more processors of a Further Reduced Capacity (F-RedCap) user equipment (UE), the instructions to configure the F-RedCap UE for operation in a Fifth Generation New Radio (5G NR) network, and to cause the F-RedCap UE to perform operations comprising: decoding a physical broadcast channel (PBCH) to obtain a numerology parameter associated with the F-RedCap UE; determining a maximum resource block (RB) allocation for a bandwidth associated with the numerology parameter; adjusting the maximum RB allocation based on a reduced bandwidth associated with the F-RedCap UE to obtain an adjusted RB allocation; determining a maximum data rate based on the numerology parameter and the adjusted RB allocation; and encoding data for an uplink (UL) transmission to a base station, the UL transmission using the maximum data rate.
In Example 14, the subject matter of Example 13 includes, the reduced bandwidth is below 20 MHz and the adjusted RB allocation is 25 RBs for a sub-carrier spacing (SCS) of 15 kHz.
In Example 15, the subject matter of Examples 13-14 includes, the reduced bandwidth is below 20 MHz and the adjusted RB allocation is 12 RBs for a sub-carrier spacing (SCS) of 30 kHz.
In Example 16, the subject matter of Examples 13-15 includes, the operations further comprising: decoding system information block (SIB) signaling received from the base station, the SIB signaling configuring a first initial UL bandwidth part (BWP) for the F-RedCap UE, and a second initial UL BWP for a RedCap UE or a non-RedCap UE.
In Example 17, the subject matter of Example 16 includes, the operations further comprising: encoding a physical random access channel (PRACH) preamble for transmission as a message-1 (msg1) in a RACH occasion (RO) configured in the first initial UL BWP.
In Example 18, the subject matter of Example 17 includes, the operations further comprising: decoding a random access response (RAR) message from the base station, and the RAR message including a scheduling grant in the first initial UL BWP.
In Example 19, the subject matter of Example 18 includes, the operations further comprising: encoding a physical uplink shared channel (PUSCH) for a message-3 (msg3) transmission to the base station, wherein the msg3 transmission is within the first initial UL BWP and is based on the scheduling grant.
In Example 20, the subject matter of Examples 18-19 includes, the scheduling grant indicating a RO allocation of at most 25 RBs for a sub-carrier spacing (SCS) of 15 kHz.
Example 21 is at least one machine-readable medium including instructions that, when executed by processing circuitry, cause the processing circuitry to perform operations to implement any of Examples 1-20.
Example 22 is an apparatus comprising means to implement any of Examples 1-20.
Example 23 is a system to implement any of Examples 1-20.
Example 24 is a method to implement any of Examples 1-20. Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

1-38. (canceled)

39. An apparatus for a Reduced Capability (RedCap) user equipment (UE) configured for operation in a Fifth Generation New Radio (5G NR) network, the apparatus comprising: processing circuitry, wherein to configure the UE for the operation in the 5G NR network, the processing circuitry is to:
encode first higher layer signaling for transmission to a base station, the first higher layer signaling indicating a maximum number of supported multiple-input-multiple-output (MIMO) layers for the RedCap UE;
encode second higher layer signaling for transmission to the base station, the second higher layer signaling indicating a maximum supported modulation order for the RedCap UE; encode third higher layer signaling for transmission to the base station, the third higher layer signaling indicating a scaling factor for the RedCap UE;
determine a maximum data rate for the RedCap UE based on a product of the maximum number of supported MIMO layers, the maximum supported modulation order, and the scaling factor, the product being smaller than 4; and
encode uplink (UL) data for a UL transmission to the base station or decode downlink (DL) data received in a DL transmission from the base station based on the maximum data rate for the RedCap UE; and
a memory coupled to the processing circuitry and configured to store the maximum data rate.

40. The apparatus of claim 39, wherein the maximum data rate is further based on a maximum physical resource block (PRB) allocation, and wherein the maximum PRB allocation equals 25 PRBs for sub-carrier spacing (SCS) of 15 kHz.

41. The apparatus of claim 39, wherein the maximum data rate is further based on a maximum physical resource block (PRB) allocation, and wherein the maximum PRB allocation equals 12 PRBs for sub-carrier spacing (SCS) of 30 KHz.

42. The apparatus of claim 39, wherein the processing circuitry is to:
select one or more random access resources configured for RedCap UEs; and
perform a random access procedure based on the selected one or more random access resources.

43. The apparatus of claim 39, wherein the processing circuitry is to: decode a physical broadcast channel (PBCH) to obtain a numerology parameter associated with the RedCap UE;
determine a maximum physical resource block (PRB) allocation for a bandwidth associated with the numerology parameter; and
determine the maximum data rate further based on the maximum PRB allocation.

44. The apparatus of claim 39, wherein the processing circuitry is to: decode system information block (SIB) signaling received from the base station, the SIB signaling to configure a first initial UL bandwidth part (BWP) for the RedCap UE and a second initial UL BWP for a non-RedCap UE; and
encode a physical random access channel (PRACH) preamble for transmission as a message-1 (msg1) in a RACH occasion (RO) configured in the first initial UL BWP.

45. The apparatus of claim 44, wherein the processing circuitry is to:
decode a random access response (RAR) message from the base station, the RAR message including a scheduling grant in the first initial UL BWP.

46. The apparatus of claim 45, wherein the processing circuitry is to:
encode a physical uplink shared channel (PUSCH) for a message-3 (msg3) transmission to the base station, wherein the msg3 transmission is within the first initial UL BWP and is based on the scheduling grant.

47. The apparatus of claim 39, further comprising:
transceiver circuitry coupled to the processing circuitry; and
one or more antennas coupled to the transceiver circuitry.

48. A non-transitory computer-readable storage medium that stores instructions for execution by one or more processors of a Reduced Capability (RedCap) user equipment (UE), the instructions to configure the RedCap UE for operation in a Fifth Generation New Radio (5G NR) network, and to cause the RedCap UE to perform operations comprising:
encoding first higher layer signaling for transmission to a base station, the first higher layer signaling indicating a maximum number of supported multiple-input-multiple-output (MIMO) layers for the RedCap UE;
encoding second higher layer signaling for transmission to the base station, the second higher layer signaling indicating a maximum supported modulation order for the RedCap UE; encoding third higher layer signaling for transmission to the base station, the third higher layer signaling indicating a scaling factor for the RedCap UE;
determining a maximum data rate for the RedCap UE based on a product of the maximum number of supported MIMO layers, the maximum supported modulation order, and the scaling factor, the product being smaller than 4; and
encoding uplink (UL) data for a UL transmission to the base station or decoding downlink (DL) data received in a DL transmission from the base station based on the maximum data rate for the RedCap UE.

49. The non-transitory computer-readable storage medium of claim 48, wherein the maximum data rate is further based on a maximum physical resource block (PRB) allocation, and wherein the maximum PRB allocation equals 25 PRBs for sub-carrier spacing (SCS) of 15 kHz.

50. The non-transitory computer-readable storage medium of claim 48, wherein the maximum data rate is further based on a maximum physical resource block (PRB) allocation, and wherein the maximum PRB allocation equals 12 PRBs for sub-carrier spacing (SCS) of 30 kHz.

51. The non-transitory computer-readable storage medium of claim 48, the operations comprising:
selecting one or more random access resources configured for RedCap UEs; and
performing a random access procedure based on the selected one or more random access resources.

52. A Reduced Capability (RedCap) user equipment (UE) configured for operation in a Fifth Generation New Radio (5G NR) network, the RedCap UE comprising:
front-end circuitry coupled to one or more antennas;
processing circuitry coupled to the front-end circuitry, the processing circuitry is to: encode first higher layer signaling for transmission to a base station, the first higher layer signaling indicating a maximum number of supported multiple-input-multiple-output (MIMO) layers for the RedCap UE;
encode second higher layer signaling for transmission to the base station, the second higher layer signaling indicating a maximum supported modulation order for the RedCap UE;
encode third higher layer signaling for transmission to the base station, the third higher layer signaling indicating a scaling factor for the RedCap UE;
determine a maximum data rate for the RedCap UE based on a product of the maximum number of supported MIMO layers, the maximum supported modulation order, and the scaling factor, the product being smaller than 4; and
encode uplink (UL) data for a UL transmission to the base station or decode downlink (DL) data received in a DL transmission from the base station based on the maximum data rate for the RedCap UE.

53. The RedCap UE of claim 52, wherein the maximum data rate is further based on a maximum physical resource block (PRB) allocation, and wherein the maximum PRB allocation equals 25 PRBs for sub-carrier spacing (SCS) of 15 kHz.

54. The RedCap UE of claim 52, wherein the maximum data rate is further based on a maximum physical resource block (PRB) allocation, and wherein the maximum PRB allocation equals 12 PRBs for sub-carrier spacing (SCS) of 30 KHz.

55. The RedCap UE of claim 52, wherein the processing circuitry is to:
select one or more random access resources configured for RedCap UEs; and
perform a random access procedure based on the selected one or more random access resources.

56. The RedCap UE of claim 52, wherein the processing circuitry is to:
decode a physical broadcast channel (PBCH) to obtain a numerology parameter associated with the RedCap UE;
determine a maximum physical resource block (PRB) allocation for a bandwidth associated with the numerology parameter; and
determine the maximum data rate further based on the maximum PRB allocation.

57. The RedCap UE of claim 52, wherein the processing circuitry is to:
decode system information block (SIB) signaling received from the base station, the SIB signaling to configure a first initial UL bandwidth part (BWP) for the RedCap UE and a second initial UL BWP for a non-RedCap UE; and
encode a physical random access channel (PRACH) preamble for transmission as a message-1 (msg1) in a RACH occasion (RO) configured in the first initial UL BWP.

58. The RedCap UE of claim 57, wherein the processing circuitry is to:
decode a random access response (RAR) message from the base station, the RAR message including a scheduling grant in the first initial UL BWP; and
encode a physical uplink shared channel (PUSCH) for a message-3 (msg3) transmission to the base station, wherein the msg3 transmission is within the first initial UL BWP and is based on the scheduling grant.
